(19) United States
(12) Patent Application Publication
(10) Pub. No.: US 2026/0278397 A1
(43) Pub. Date: Sep. 17, 2026

(54) TWO-SIDED MODEL TRAINING

(71) Applicant: Lenovo (Singapore) Pte. Limited, Singapore (SG)

(72) Inventors: Vahid Pourahmadi, München (DE); Ahmed Hindy, Aurora, IL (US); Venkata Srinivas Kothapalli, Aurora, IL (US); Vijay Nangia, Woodridge, IL (US)

(73) Assignee: Lenovo (Singapore) Pte. Limited, Singapore (SG)

(21) Appl. No.: 19/471,321

(22) PCT Filed: Apr. 5, 2024
(86) PCT No.: PCT/IB2024/053382

§ 371 Date: Sep. 30, 2025

Related U.S. Application Data
(60) Provisional application No. 63/494,720, filed on Apr. 6, 2023.
(60) Provisional application No. 63/494,722, filed on Apr. 6, 2023.

(51) Int. Cl. G06N 3/098; G06N 3/0455

(52) U.S. Cl. CPC G06N 3/098; G06N 3/0455

(57) ABSTRACT

Various aspects of the present disclosure relate to an apparatus for two-sided model training. The apparatus, such as a UE determines a first set of parameters characterizing an encoder model of the apparatus based on a first set of information. The UE determines a second set of parameters characterizing a decoder model of the apparatus based on the first set of information. The UE transmits a second set of information to a second device, the second set of information is usable to determine a decoder of the second device, and the second set of information is determined based on the first or the second set of parameters. The UE receives, from the second device, feedback information representing the decoder of the second device. The UE updates the second set of parameters characterizing the decoder model of the UE based on the feedback information representing the decoder of the second device.

### RELATED APPLICATION

This application claims priority to U.S. Provisional Application Ser. No. 63/494,722 filed Apr. 6, 2023 entitled “Two-Sided Model Training,” the disclosure of which is incorporated by reference herein in its entirety. This application also claims priority to U.S. Provisional Application Ser. No. 63/494,720 filed Apr. 6, 2023 entitled “Two-Sided Model Performance Monitoring,” the disclosure of which is incorporated by reference herein in its entirety.

### TECHNICAL FIELD

The present disclosure relates to wireless communications, and more specifically to two-sided models.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, a two-sided model includes a UE side and a network (e.g., gNB) side. Common techniques used to determine whether the two-sided model is performing appropriately include comparing an output of the gNB side of the model with the input at the UE side of the model, using a conventional feedback mechanism. However, feedback of the correct output of the gNB side of the model is not a straightforward task, even using a conventional feedback mechanism, and a signaling overhead is incurred for the transmission.

### SUMMARY

The present disclosure relates to methods, apparatuses, and systems that support two-sided model training. In aspects of two-sided model performance modeling, this disclosure describes details for techniques to monitor the performance of a two-sided model, such as by sending the expected output to the second node for monitoring, using the local-decoder model generated during separate training at the first node, using the updated local-decoder model which is fine-tuned to better match the actual decoder of the second node (which also provides an iterative approach to improve the quality of the local decoder-model), and/or the first node constructs a local version of the actual decoder (at the second node) and uses it for model monitoring.

In further aspects of two-sided model training, this disclosure describes details of techniques for training and updating a two-sided models. Notably, the described techniques improve the performance of a trained two-sided model in an iterative manner. The described techniques compensate the performance loss of a two-sided model if there is a difference between the data and models used or assumed at different first or second nodes of the two-sided model. The training techniques are implemented as first-node-first and second-node-first schemes. Further, there is not a need to share the encoder model of the first nodes and the decoder model of the second nodes with each other, and the training of the first and/or second node(s) does not need to be at the same time.

Notably, advantages of the separate training include the first and the second nodes do not need to be aware of the internal structure of the neural network (NN) module of the other side. In one or more implementations of a two-sided model, the described techniques train and/or update a two-sided model in separate training loops, and removes the inconsistency in the separate training of a two-sided model.

In some implementations of the method and apparatuses described herein, a UE determines a first set of parameters characterizing an encoder model of the apparatus based at least in part on a first set of information, and determines a second set of parameters characterizing a decoder model of the apparatus based at least in part on the first set of information. The UE transmits a second set of information to at least one second device, where the second set of information is usable to determine a decoder of the second device, and the second set of information is determined based on at least one of the first set of parameters or the second set of parameters. The UE receives, from the second device, feedback information representing the decoder of the second device. The UE updates the second set of parameters characterizing the decoder model of the apparatus based at least in part on the feedback information representing the decoder of the second device.

Some implementations of the method and apparatuses described herein may further include the UE updates the first set of parameters characterizing the encoder model of the apparatus based at least in part on the update of the second set of parameters and a third set of information. A third set of information includes a set of samples representing at least an input and an expected output of a model. The UE updates the first set of parameters characterizing the encoder model of the apparatus based at least in part on the third set of information; and a serial concatenation of the encoder model based on the updated first set of parameters and the updated decoder model generates approximately similar input and output data pairs at least for the set of samples of the third set of information. The UE determines to repeat an update and performs the update by iterating at least to: transmit, to the second device, an updated second set of information that is based on at least one of an updated first set of parameters or an updated second set of parameters; receive, from the second device, the feedback information representing the decoder of the second device; repeat the update of the second set of parameters characterizing the decoder model based at least in part on the feedback information representing the decoder of the second device; and repeat the update of the first set of parameters characterizing the encoder model of the apparatus based at least in part on the update of the second set of parameters and a third set of information. The UE stops an iterative update based at least in part on an update procedure exceeding a threshold amount of time, a training loss of the encoder model or the decoder model is less than a threshold, or if the apparatus is directed to stop the iterative update. A two-sided model has a UE side and a network side, and the apparatus is a first network node at the UE side, and the at least one second device is a second network node at the network side.

Additionally, the first set of information includes data samples representing at least an input and an expected output of a two-sided model that includes the encoder model and a decoder model of the apparatus. The first set of information and output data of the two-sided model are based at least in part on channel state information (CSI). The UE determines a latent representation of the first set of information based at least in part on the encoder model, and generates the expected output based at least in part on the latent representation and the decoder model. The first set of parameters and the second set of parameters are utilized to determine NN parameters of one or more NN modules associated with the encoder model and the decoder model. The second set of information includes data samples representing at least one of an input and an expected output of the decoder model. The input of the decoder model is an output of the encoder model. The second set of information includes at least characterizing information of the decoder model. The feedback information includes samples representing at least one of an input and an expected output of the decoder model. The decoder model generates approximately similar input and output data pairs at least for samples of the feedback information based at least in part on the second set of parameters being updated to characterize the decoder model. The UE communicates an indication to at least one of the second device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

In some implementations of the method and apparatuses described herein, a gNB receives a first set of information from at least one first device, where the first set of information includes at least characterizing information of an encoder model or a decoder model of the first device. The gNB determines a first set of parameters representing a decoder model of the apparatus based at least in part on the first set of information. The gNB transmits feedback information to the at least one first device to update parameters characterizing the decoder model at the first device, where the feedback information is based on at least one of the decoder model of the apparatus or a second set of information.

Some implementations of the method and apparatuses described herein may further include the gNB determines to repeat an update, and performs the update by iterating at least to: receive the first set of information from the at least one first device; determine the first set of parameters representing the decoder model of the apparatus based at least in part on the first set of information; and transmit the feedback information to the at least one first device to update the parameters characterizing the decoder model at the first device. The two-sided model has a UE side and a network side, and the apparatus is a first network node at the network side, and the at least one first device is a second network node at the UE side. The first set of information includes the characterizing information of the decoder model of a two-sided model. The first set of information includes data samples representing at least an input and an expected output of the decoder model of a two-sided model. The first set of parameters are utilized to determine NN parameters of one or more NN modules associated with the decoder model. The first set of parameters are determined such that the decoder model generates approximately similar input and output data pairs at least for samples of the first set of information. A second set of information includes a set of samples representing at least an input to the decoder model of a two-sided model. The feedback information includes data samples representing at least an input and an output of the decoder model. The gNB stops an iterative update based at least in part on an update procedure exceeding a threshold amount of time, a training loss of the encoder model or the decoder model is less than a threshold, or if the apparatus is directed to stop the iterative update. The gNB communicates an indication to at least one of the first device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

In some implementations of the method and apparatuses described herein, a gNB determines a first set of parameters characterizing an encoder model of the apparatus based at least in part on a first set of information, and determines a second set of parameters characterizing a decoder model of the apparatus based at least in part on the first set of information. The gNB transmits a second set of information to at least one second device, where the second set of information is usable to determine an encoder of the second device, and the second set of information is determined based on at least one of the first set of parameters or the second set of parameters. The gNB receives, from the second device, feedback information representing the encoder of the second device, and updates the first set of parameters characterizing the encoder model of the apparatus based at least in part on the feedback information representing the encoder of the second device.

Some implementations of the method and apparatuses described herein may further include the gNB updates the second set of parameters characterizing the decoder model of the apparatus based at least in part on the update of the first set of parameters and a third set of information. A third set of information includes a set of samples representing at least an input and an expected output of a model. The gNB updates the second set of parameters characterizing the decoder model of the apparatus based at least in part on the third set of information; and a serial concatenation of the decoder model based on the updated second set of parameters and the updated encoder model generates approximately similar input and output data pairs at least for the set of samples of the third set of information. The gNB determines to repeat an update, and performs the update by iterating at least to: transmit, to the second device, an updated second set of information that is based on at least one of an updated first set of parameters or an updated second set of parameters; receive, from the second device, the feedback information representing the encoder of the second device; repeat the update of the first set of parameters characterizing the encoder model based at least in part on the feedback information representing the encoder of the second device; and repeat the update of the second set of parameters characterizing the decoder model of the apparatus based at least in part on the update of the first set of parameters and a third set of information. The gNB stops an iterative update based at least in part on an update procedure exceeding a threshold amount of time, a training loss of the decoder model or the encoder model is less than a threshold, or if the apparatus is directed to stop the iterative update.

Additionally, a two-sided model has a UE side and a network side, and the apparatus is a first network node at the network side, and the at least one second device is a second network node at the UE side. The first set of information includes data samples representing at least an input and an expected output of a two-sided model that includes the decoder model and an encoder model of the apparatus. The first set of information and output data of the two-sided model are based at least in part on CSI. The gNB determines a latent representation of the first set of information based at least in part on the decoder model; and generates the expected output based at least in part on the latent representation and the encoder model. The first set of parameters and the second set of parameters are utilized to determine NN parameters of one or more NN modules associated with the encoder model and the decoder model. The second set of information includes data samples representing at least one of an input and an expected output of the encoder model. The input of the encoder model is an output of the decoder model. The second set of information includes at least characterizing information of the encoder model. The feedback information includes samples representing at least one of an input and an expected output of the encoder model. The encoder model generates approximately similar input and output data pairs at least for samples of the feedback information based at least in part on the first set of parameters being updated to characterize the encoder model. The gNB communicates an indication to at least one of the second device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

In some implementations of the method and apparatuses described herein, a UE receives a first set of information from at least one first device, where the first set of information includes at least characterizing information of an encoder model or a decoder model of the first device. The UE determines a first set of parameters representing an encoder model of the apparatus based at least in part on the first set of information. The UE transmits feedback information to the at least one first device to update parameters characterizing the encoder model at the first device, the feedback information being based on at least one of the encoder model of the apparatus or a second set of information.

Some implementations of the method and apparatuses described herein may further include the UE determines to repeat an update, and performs the update by iterating at least to: receive the first set of information from the at least one first device; determine the first set of parameters representing the encoder model of the apparatus based at least in part on the first set of information; and transmit the feedback information to the at least one first device to update the parameters characterizing the encoder model at the first device. A two-sided model has a UE side and a network side, and the apparatus is a first network node at the UE side, and the at least one first device is a second network node at the network side. The first set of information includes characterizing information of the encoder model of a two-sided model. The first set of information includes data samples representing at least an input and an expected output of the encoder model of a two-sided model. The first set of parameters are utilized to determine NN parameters of one or more NN modules associated with the encoder model. The first set of parameters are determined such that the encoder model generates approximately similar input and output data pairs at least for samples of the first set of information. A second set of information includes a set of samples representing at least an input to the encoder model of a two-sided model. The feedback information includes data samples representing at least an input and an output of the encoder model. The UE stops an iterative update based at least in part on an update procedure exceeding a threshold amount of time, a training loss of the decoder model or the encoder model is less than a threshold, or if the apparatus is directed to stop the iterative update. The UE communicates an indication to at least one of the first device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

### BRIEF DESCRIPTION OF THE DRAWINGS

FIG. 1 illustrates an example of a wireless communications system that supports two-sided model training in accordance with aspects of the present disclosure.

FIG. 2 illustrates an example of a wireless network including a gNB (e.g., a base station) and multiple UEs, as related to two-sided model training in accordance with aspects of the present disclosure.

FIG. 3 illustrates an example of a high-level structure of a two-sided model, as related to two-sided model training in accordance with aspects of the present disclosure.

FIG. 4 illustrates an example of another high-level structure of a two-sided model with multiple encoders, as related to two-sided model training in accordance with aspects of the present disclosure.

FIGS. 5a and 5b illustrate an example of a CSI system with a UE subsystem and a network subsystem that supports operation of a two-sided model, as related to two-sided model training in accordance with aspects of the present disclosure.

FIG. 6 illustrates an example of a two-sided model and training for performance monitoring, as related to two-sided model training in accordance with aspects of the present disclosure.

FIGS. 7 and 8 illustrate an example of a block diagram of devices that supports two-sided model training in accordance with aspects of the present disclosure.

FIGS. 9-20 illustrate flowcharts of methods that support two-sided model training in accordance with aspects of the present disclosure.

### DETAILED DESCRIPTION

A wireless communications system includes a two-sided model with a UE side and a network (e.g., gNB) side. Common techniques used to determine whether the two-sided model is performing appropriately include comparing an output of the gNB side of the model with the input at the UE side of the model, using a conventional feedback mechanism. However, feedback of the correct output of the gNB side of the model is not a straightforward task, even using a conventional feedback mechanism, and a signaling overhead is incurred for the transmission.

In aspects of two-sided model performance modeling, this disclosure describes details for techniques to monitor the performance of a two-sided model, such as by sending the expected output to the second node for monitoring, using the local-decoder model generated during separate training at the first node, using the updated local-decoder model which is fine-tuned to better match the actual decoder of the second node (which also provides an iterative approach to improve the quality of the local decoder-model), and/or the first node constructs a local version of the actual decoder (at the second node) and uses it for model monitoring.

Further, as described above, the parameters of a two-sided model are trained before it can effectively feedback the information to the gNB. The model is trained by presenting a set of input and desired output to the model (the training data set), which the model uses to find the statistics of the input and the input/output relation, and capture that in the parameters of the model. The trained model can be used as long as the statistics of the input and/or the input/output relation remains similar to what has been presented to the model during the training time, or the model could be generalized well to the new situation. In other aspects, the described techniques are directed to how the system of a two-sided model (e.g., gNB and/or UE) determines that the model is not performing appropriately. For example, the quantity of data and signaling needed to implement a monitoring procedure is taken into consideration for the techniques.

In aspects of two-sided model training, this disclosure describes details of techniques for training and updating a two-sided models. Notably, the described techniques improve the performance of a trained two-sided model in an iterative manner. The described techniques compensate the performance loss of a two-sided model if there is a difference between the data and models used or assumed at different first or second nodes of the two-sided model. The training techniques are implemented as first-node-first and second-node-first schemes. Further, there is not a need to share the encoder model of the first nodes and the decoder model of the second nodes with each other, and the training of the first and/or second node(s) does not need to be at the same time.

In further aspects of two-sided model training, the described techniques provide for training and iteratively updating a two-sided model in separate training loops. The described techniques are directed to separate training and model updates, where the NN modules of a first node (e.g., a UE) and a second node (e.g., a gNB) are trained in different training sessions, without forward or backpropagation paths between the UE and the gNB. Notably, an advantage of the separate training is that the first and the second nodes do not need to be aware of the internal structure of the NN module of the other side. In one or more implementations of a two-sided model, the described techniques train and/or update a two-sided model in separate training loops, and removes the inconsistency in the separate training of a two-sided model.

Aspects of the present disclosure are described in the context of a wireless communications system. Aspects of the present disclosure are further illustrated and described with reference to device diagrams and flowcharts.

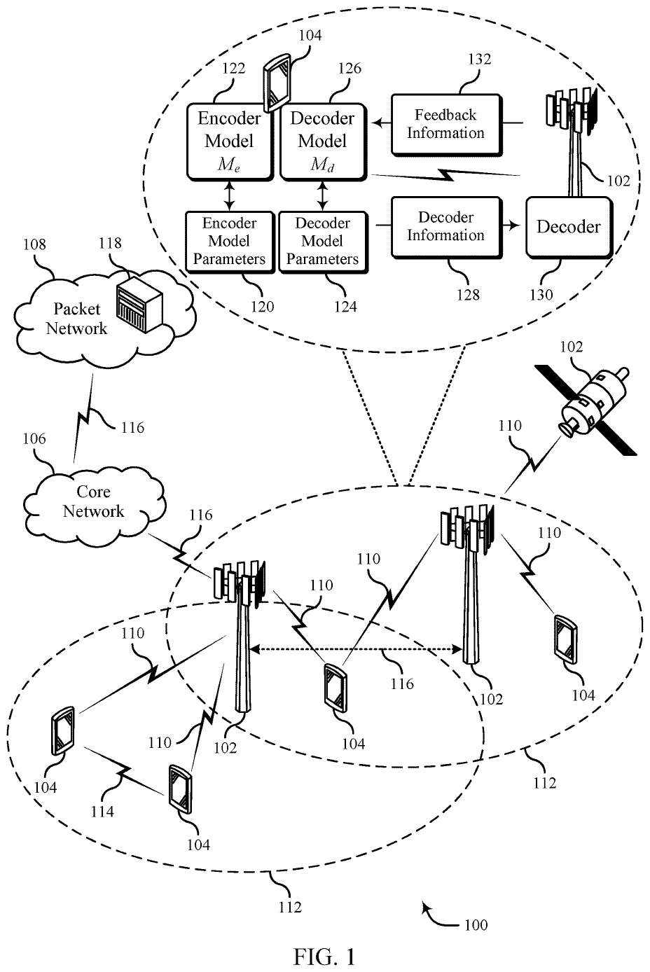

FIG. 1 illustrates an example of a wireless communications system 100 that supports two-sided model training in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity (NE) 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AM4F)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=³) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, such as for two-sided model training, one or more of the network entities 102 and the UEs 104 are operable to implement various aspects of the techniques described herein. For instance, a UE 104 determines a first set of parameters 120 characterizing an encoder model 122 of the UE based on a first set of information. The UE 104 also determines a second set of parameters 124 characterizing a decoder model 126 of the UE based on the first set of information. The UE transmits decoder information 128 to the gNB, which is usable to determine a decoder 130 of the gNB. The gNB receives the decoder information 128 from the UE 104, which includes characterizing information of the encoder model 122 and/or the decoder model 126 of the UE. The gNB transmits feedback information 132 to the UE 104 to update the parameters 124 that characterize the decoder model 126 at the UE, and the UE 104 updates the parameters 124 that characterize the decoder model 126 of the UE based on the feedback information 132 that represents the decoder 130 of the gNB.

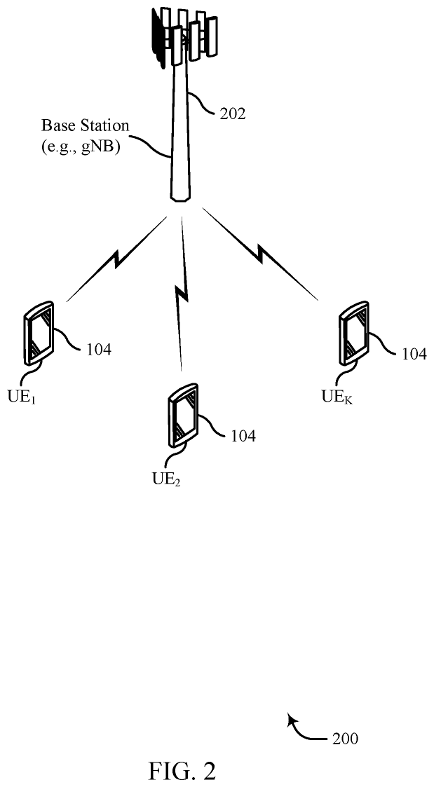

FIG. 2 illustrates an example 200 of a wireless network including a gNB (e.g., a base station) and multiple UEs, as related to two-sided model training. In this example 200, the wireless network includes a gNB 202 (e.g., a base station, network entity 102) and multiple (K) UEs 104. The UEs, for instance, include a UE₁, UE₂, and UE_{K}. The base station can be represented as a node B₁ equipped with M antennas and the K UEs denoted by U₁, U₂, . . . , U_{K} with each having N antennas. In this example,

$${H}_{l}^{k}$$

(t) can denote a channel at time t over a frequency band l, l∈{1, 2, . . . , L}, between B₁ and Uₖ which is a matrix of size N×M with complex entries, i.e.,

$${H}_{l}^{k}$$

(t)∈ [symbol] ^{N×M}.

At time t and frequency band l, it can be assumed that the base station is to transmit a message

$${x}_{l}^{k}$$

(t) to U_{K}, where K={1, 2, . . . , K} while the base station uses

$${w}_{l}^{k}$$

(t)∈ [symbol] ^{M×1} as the precoding vector. The received signal at Uₖ,

$${y}_{l}^{k}$$

(t), can be indicated as:

$${y}_{l}^{k} ( t ) = {H}_{l}^{k} ( t ) {w}_{l}^{k} ( t ) {x}_{l}^{k} ( t ) + {n}_{l}^{k} ( t )$$

where

$${n}_{l}^{k}$$

(t) represents the noise vector at the receiver.

To improve the achievable rate of the link, the gNB 202 can select

$${w}_{l}^{k}$$

(t) that maximizes the received signal-to-noise ratio (SNR). Several schemes have been proposed for selection of

$${w}_{l}^{k}$$

(t) where some rely on having some knowledge about

$${H}_{l}^{k}$$

(t). The gNB can obtain knowledge of

$${H}_{l}^{k}$$

(t) by direct measurement (e.g., in time-division duplexing (TDD) mode and assuming reciprocity of the channel), or indirectly using information that a UE sends to the gNB (e.g., in frequency-division duplexing (FDD) mode). In the latter case, a large amount of feedback may be needed to send accurate information about

$${H}_{l}^{k}$$

(t), which is important for a large number of antennas and/or large frequency bands.

As described herein, implementations are discussed with reference to a single time slot. However, implementations of the described techniques can be further extended to more than a single time slot. Thus,

$${H}_{l}^{k}$$

(t) can be denoted using

$${H}_{l}^{k} .$$

The H^{k}(t) can be defined as matrix of size N×M×L which can be composed by stacking

$${H}_{l}^{k}$$

for multiple frequency bands (e.g., the entries at H^{k}[n,m,l](t) can be equal to

$${H}_{l}^{k}$$

[n, m](t)). Thus, each UE can be feeding back the information about the most recent N×M× L complex numbers to the gNB.

Several proposed schemes attempt to reduce the rate of required feedback. For instance, a group of these schemes, generally referred to as two-sided methods, include two parts where a first part is deployed at the UE side and the second part is deployed at the gNB side. The UE and gNB sides include one or more neural network blocks which are trained using data driven approaches. The UE side can compute a latent representation of input data (e.g., to be transferred to the gNB), such as with as low of a number of bits as possible. The gNB can receive data transmitted by the UE side, and the gNB attempts to reconstruct the information intended by the UE to be transmitted to the gNB. There are several methods to train the neural network (NN) modules of a two-sided model, including, centralized training, simultaneous training, and separate training. Similarly, updating a two-sided model can be carried out centrally on one entity, on different entities but simultaneously, or separately.

In implementations to reduce the required feedback information, an encoding part (at the UE) computes a quantized latent representation of the input data, and the decoding part (at the gNB) gets this latent representation and uses that to reconstruct the desired output. The input data in this case can be data which is based on the channel measurements. For example, it could be the raw channel inputs of H^{k} or

$${H}_{l}^{k} ,$$

or for example, the precoders that are computed from the channel matrix (e.g., the eigenvector associated to the largest eigen-vector of H^{k} for each sub-band).

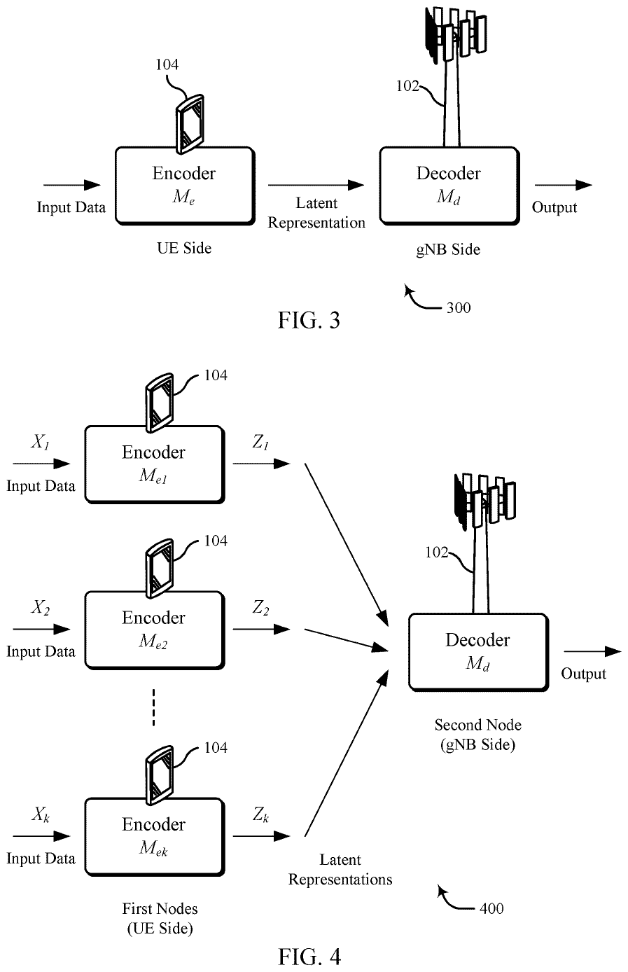

FIG. 3 illustrates an example 300 of a high-level structure of a two-sided model, as related to two-sided model training in accordance with aspects of the present disclosure. In this example 300, the two-sided model includes a neural network-based UE 104 (e.g., a first node) and a gNB (network entity 102) (e.g., a second node) referred to in this example as Mₑ (encoder or encoding model) and M_{d} (decoder or decoding model), respectively. The input of the two-sided model can be based on the channel measurement, such as for example, a raw channel measurement or eigenvectors associated to the measured channel.

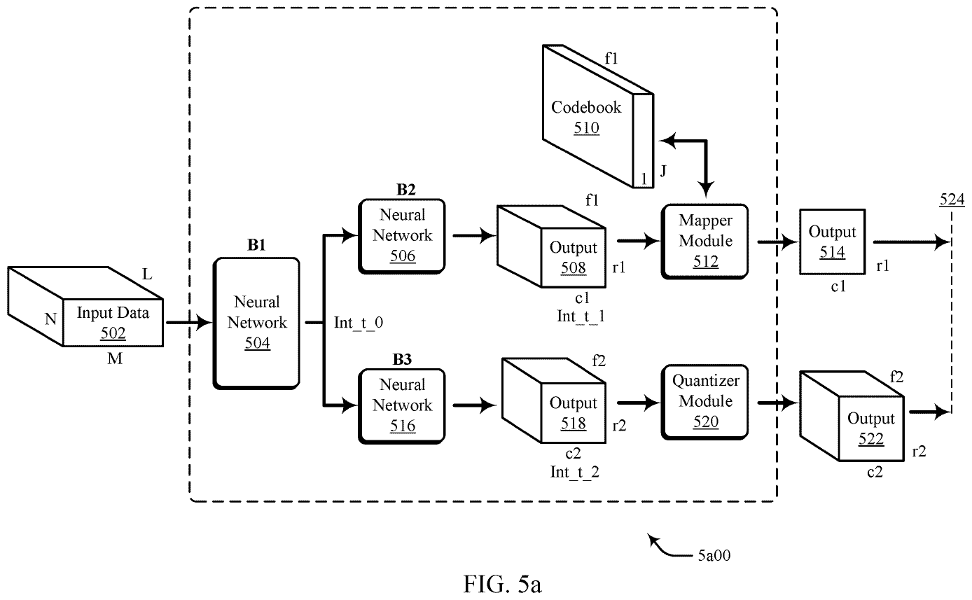

FIG. 4 illustrates an example 400 of another high-level structure of a two-sided model with multiple encoders, as related to two-sided model training in accordance with aspects of the present disclosure. In implementation extensions of the two-sided model (as shown and described with reference to FIG. 3), the encoder or the decoder parts of the two-sided model are shared. In this example 400, the two-sided model includes multiple a neural network-based UEs 104 (e.g., first nodes, shared encoders Me) and the gNB (network entity 102) (e.g., a second node, decoder M_{d}). In implementations, the structure of the UE side and/or the gNB side can vary depending on the particular two-sided model and scheme. Alternatively, a similar structure can be implemented with multiple decoders (e.g., at multiple gNBs) with a single encoder (e.g., at a UE), or a structure with multiple encoders and multiple decoders.

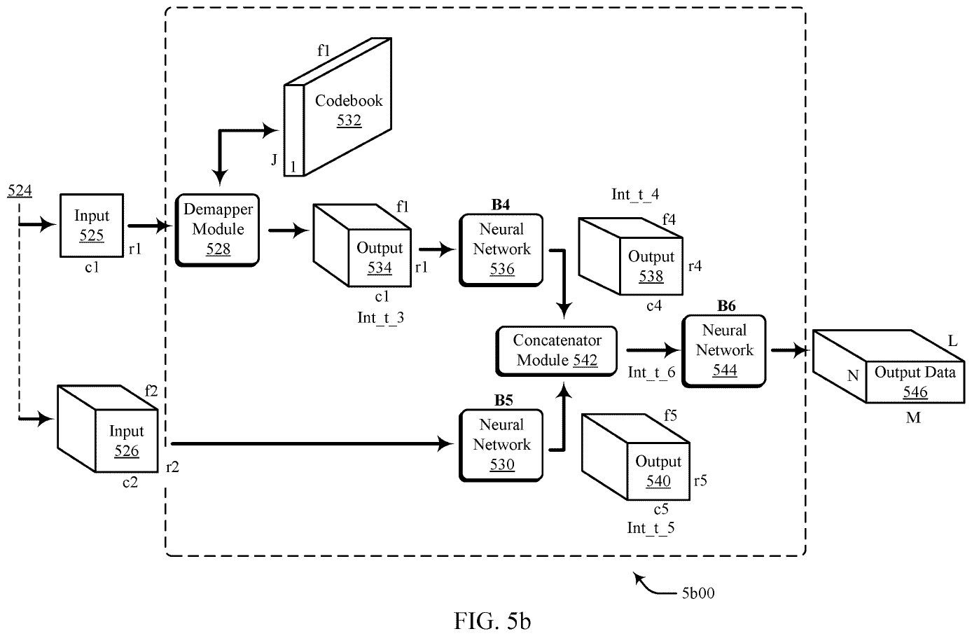

FIGS. 5a and 5b illustrate an example of a CSI system 500, with a UE subsystem 500a and a network subsystem 500b that supports operation of a two-sided model, as related to two-sided model training in accordance with aspects of the present disclosure. In at least one implementation the network subsystem 500b is implemented at a network entity 102 (e.g., a gNB). As further detailed below, and in aspects of the described techniques, the UE side (e.g., the UE subsystem 500a) sends the latest H^{k}[n,m,l](t) to the gNB side (e.g., the network subsystem 500b). In this figure, blocks B1 to B6 are multilayer neural networks (NNs). The encoder part first generates two latent representations of the input data (i.e., Int_t_1 and Int_t_2). The encoder part then quantizes these latent representations using vector and value quantization methods, respectively. The results are then transmitted to the gNB side, where the decoder part generates an output, such as the reconstruction of the input data. In this structure, the UE and gNB quantization codebook (510, 532) are assumed to be the same and their value along the weights of the NNs (for all blocks) will be learned during the training phase. Other hyperparameters like a value of J and the number of quantization levels (Q) for the quantizer module 520 can also be set during the training phase. Noting that the described structure, the input/output, and the 3D shape of blocks are for the purpose of illustration and any other structure can be used for the two-sided model.

According to one or more implementations, two latent representations of input data are generated. In at least one example, the input data is the channel matrix H and/or based on the channel matrix such as a function of the channel matrix, e.g., channel covariance matrix, eigen decomposition such as at least one eigen vectors, singular value decomposition (SVD) such as the at least one vector of the left and/or right singular vectors, etc. According to implementations the latent representations contain “real” numbers and thus it may not be practicable to send the latent representations directly using a finite number of feedback bits.

Accordingly, at the lower branch (e.g., scalar quantization branch), the UE subsystem 500a quantizes real values of a latent representation and sends the quantized version to the network subsystem 500b (e.g., network entity such as gNB). In at least one example, the quantization occurring in the lower branch is based on a linear quantization with Q levels. At the upper branch (e.g., the quantization using codebook branch) the UE subsystem 500a compares the latent representation against codewords of a codebook and then instead of sending the actual latent representation, the UE subsystem 500a can transmit the ID(s) and/or index(s) of at least one codeword based on a measure of correlation or similarity of the indicated codeword(s) and the actual latent representation, such as the closest codeword(s), a weighted combination of a subset of the codewords, etc. Note that the codewords of the codebook are not fixed and can be learned during a training phase.

Additionally, the various blocks of the network subsystem 500b can be trained to use the bits received from the UE subsystem 500a (e.g., feedback CSI bits such as those corresponding to the two latent representations) to generate a desired output. In at least some examples, a training objective is to have the output data (e.g., reconstructed data) as similar as possible to the input data. Alternatively or additionally other objective functions (e.g., loss functions) may be used for training as well.

In the CSI system 500 different blocks of the system and associated procedures for the feedback CSI data can be generated at the UE subsystem 500a (e.g., a transmitter node) and then used by the network subsystem 500b (e.g., a receiver node) for reconstruction of the input data. In the UE subsystem 500a, input data 502 is input to a neural network 504. One example of the input data 502 is the H matrix as defined above. In implementations the input data 502 is a three-dimensional matrix representing a channel between Tx-Rx antenna pairs (N×M) over frequency bands, L, for a UE. In at least some examples, the frequency bands may represent the channel per subcarrier, per every x subcarriers, per subcarrier group such as a PRB or sub-PRB or RBG (resource block group), etc. Further, the input data 502 can be a function of the H matrix (e.g., a vector corresponding to a singular vector that is associated with a largest singular value of the matrix H).

The neural network 504 can be implemented as a multilayer neural network, for example using a convolutional neural network (CNN). In implementations the neural network 504 can be shared between both upper and lower branches of the UE subsystem 500a. The intermediate tensor output of neural network 504 (“Int_t_0”) may be of size c0× r0× f0. A neural network 506 (e.g., a multilayer neural network such as a CNN) receives output from the neural network 504 and generates output 508. The output 508, for instance, is a 3D intermediate tensor of size c1× r1× f1 (namely “Int_t_1”), where f1 represents, e.g., a number of filters at the last convolutional layer of the neural network 506 using CNN. In at least some implementations for each input sample (and based on the neural network 506 weights), there will be c1× r1 tensors of size 1× f1 at the output 508. Parameters c1, r1, and f1, for instance, are the hyperparameters that are determined during the training phase.

According to one or more implementations the UE subsystem 500a sends a representation of the output 508 to the network subsystem 500b using a quantization codebook 510. The quantization codebook 510, for instance, is composed of J tensors (codewords) of size 1× f1. Each of these tensors have an ID or index which can be represented using log₂ J bits (e.g., since there are J different codewords). Further to the UE subsystem 500a, a mapper module 512 receives the output 508 and for each of its c1× r1 tensors, and the mapper module 512 generates at least one ID (between 0 to J) which shows the ID of the codeword (from the quantization codebook 510) which has a closest and/or largest correlation to the output 508. For instance, for the output 508, the mapper module 512 maps the input tensor of c1× r1× f1 to c1× r1 IDs, which can each be represented using log₂ J bits to generate an output 514. Different metrics (e.g., Euclidian distance) can be used to compute the closeness between the vectors of the output 508 and the codebook 510 to generate the output 514.

The UE subsystem 500a further includes a neural network 516 which can be implemented as a multilayer neural network (e.g., using CNN). The neural network 516 receives the output from the neural network 504 (e.g., the intermediate tensor output “Int_t_0”) and generates an output 518. The output 518, for instance, represents a 3D intermediate tensor of size c2× r2× f2 (namely “Int_t_2”), where f2 is, e.g., a number of filters at a last convolutional layer of the neural network 516 realized using CNN. Further, the parameters c2, r2, and f2 are the hyperparameters that are determined during the training phase. The output 518 is not necessarily of 3D shape and may optionally be 1D or 2D tensors such as depending on the structure of the neural network 516.

To enable the UE subsystem 500a to send the output 518 and/or some representation thereof to the network subsystem 500b, and to reduce the communication overhead, it may first pass the output 518 through a quantizer module 520, which in at least some implementations represents a scalar quantizer. In at least one example, the quantizer module 520 quantizes each value of the output 518 into 2^{Q} levels (e.g., each quantized value can be represented using Q bits). The value of Q and the type of quantization used by the quantizer module 520 can be determined during the training phase. Thus, the quantizer module 520 receives the output 518 as input, and the quantizer module 520 generates an output 522, which, for instance, represents a tensor of size c2× r2× f2 where each entry takes only one of the 2^{Q} possible values.

Accordingly, the UE subsystem 500a transmits a representation of the outputs 514, 522 (e.g., encoded representations of the outputs 514, 522) to the network subsystem 500b via a feedback link 524. The outputs 514, 522 and/or representations thereof are sent (e.g., with a source and/or channel code and a modulation) to the network subsystem 500b e.g., with the feedback CSI information bits. According to implementations, the outputs 514, 522 can be sent to the network subsystem 500b using c1× r1× log₂ J+c2× r2× f2× Q bits (information bits). For instance, (c1, r1) are the number of latent vectors at the upper branch, J is the number of codewords in the quantization codebook 510 at the upper branch, (c2, r2, f2) show the size of the latent representation in lower branch, and Q is the number of level used in the scalar quantizer in the lower branch.

At the network subsystem 500b, the gNB side receives via the feedback link 524 an input 525 and an input 526 which represent the output 514 and the output 522, respectively. The network subsystem 500b feeds the input 525 to a demapper module 528 (e.g., in the upper branch) and the input 526 to a neural network 530 (e.g., in the lower branch). The demapper module 528 takes as input the received the c1× r1 “IDs” in the input 525 and replaces and/or maps them to the corresponding codeword of size 1× f1 from a quantization codebook 532 which includes J tensors (codewords) of size 1× f1. The demapper module 528 outputs an output 534, which in at least one implementation represents a 3D tensor of size c1× r1× f1 (e.g., “Int_t_3”). The quantization codebook 532 may be the same or different than the quantization codebook 510 of the UE subsystem 500a.

The network subsystem 500b further includes a neural network 536 which can be implemented as a multilayer neural network (e.g., using CNN). The neural network 536 takes the output 534 as input and generates an output 538 (“Int_t_4”). The output 538, for instance, is a 3D tensor of size c4× r4× f4. Further, parameters c4, r4, and f4 are the hyperparameters that are determined during the training phase. As mentioned above the neural network 530 takes the input 526 as input. Accordingly, the neural network 530 generates an output 540 (“Int_t_5”). The output 540, for instance, is a 3D tensor of size c5× r5× f5. Parameters c5, r5, and f5 are the hyperparameters that are determined during the training phase. In examples, c4=c5, and r4=r5.

To assist in concatenation of the outputs 538, 540, parameters c5 and r5 may be equal to c4 and r4, respectively. Considering these design parameters, c_{g} and r_{g} can be used as the first two dimensions of outputs 538, 540, e.g., output 538 can have the size of c_{g}×r_{g}×f4 and output 540 can have the size c_{g}×r_{g}×f5. Accordingly, a concatenator module 542 concatenates the outputs 538, 540 along the third dimension (e.g., filter dimension) and constructs “Int_t_6”. Thus, “Int_t_6” can be a 3D tensor of size c_{g}×r_{g}×(f4+f5).

The network subsystem 500b further includes a neural network 544, which for instance, is a multilayer neural network, such as implemented using CNN. The neural network 544 takes “Int_t_6” (output of the concatenator module 542) as input and generates output data 546. The output data 546, for example, represents a reconstructed data representation of the input data 502 previously input to the UE subsystem 500a. The output data 546 can be shared between both upper and lower branches of the network subsystem 500b. In at least some implementations, to enable reconstruction of the original input data 502, the size of the output data 546 is N×M× L.

The following sections describe implementation details for the system 500. In these sections, “UE” can refer to the UE subsystem 500a and “network,” “network entity,” and/or “gNB” can refer to the network subsystem 500b.

Considerations regarding the network structure:
a. In one example, the output of the neural network 516 is designed to be in the range [−1,1]. For example, this can be enabled by applying an appropriate activation function (e.g., “tanh”) for the last layer of the neural network 516.
b. Assuming an ideal feedback channel, input 525 and input 526 may be equal to output 514 and output 522, respectively. They could be different in cases of a non-ideal feedback channel, e.g., some elements of inputs 525, 526 are received with errors, omission of some elements of outputs 514, 522 in the feedback CSI, etc. Such effects may be modelled appropriately in the network structure of the system 500.
c. The neural network structure of the different neural networks of the system 500 can be hyperparameters and can be determined during the training phase. Note that they can be fixed during the inference phase.
d. The total available feedback rates can be partitioned between the data used for transmission of output 514 and output 522. For instance, on the selection of (c, r1), (c2, r2), the number of codewords in the quantization codebook 510, (e.g., J, and the levels of scalar quantization, e.g., Q).
e. The system 500 can be scaled down to:
   Use codebook-based quantization branch only: For this case, the lower branch of the UE subsystem 500a can be turned off or not used. In addition, neural network 530 and the concatenator module 542 can be removed from the network subsystem 500b.
   Use scalar quantization branch only: For this case the upper branch of the UE subsystem 500a can be turned off or not used. In addition, the demapper module 528, the neural network 536, and the concatenator module 542 can be removed from the network subsystem 500b. The codebook 532 may optionally not be implemented and/or utilized.
   In some examples, the network subsystem 500b (e.g., gNB) may indicate to the UE subsystem 500a (e.g., UE) to use at least one of the codebook-based quantization branch only, scalar quantization branch only, or both codebook-based quantization branch and scalar quantization branch.
   In some examples, the UE subsystem 500a may determine to feedback the output of at least one of the codebook-based quantization branch only, scalar quantization branch only, or both codebook-based quantization branch and scalar quantization branch. Such determination may be based on the input data 502, e.g., channel matrix H. The UE subsystem 500a may indicate to the network subsystem 500b an indication of such determination, e.g., the feedback CSI is based on codebook-based quantization branch only, scalar quantization branch only, or both codebook-based quantization branch and scalar quantization branch.
f. A similar framework can be used when the input data 502 is not directly equal to the matrix H. The input data 502, alternatively, could be an input data represented as a 3D matrix, e.g., a DFT transformed version of the channel matrix or a matrix representing the one/several eigen vectors and/or eigen value(s) of the channel matrix in different frequency bands. Alternatively or additionally, the input data 502 may correspond to a set of at least one precoding vector that is associated with a downlink transmission from a network node to the UE. As some other examples, H could be of size N×M×T where the third dimension represents values at different time symbols and/or time slots or could of size N×M×Z where the third dimension represents a composite time/frequency domain (e.g., a stacked or concatenated frequency and time-domain vectors).
g. The entries of H can be complex numbers and since most of the neural network methods work with real numbers, a transformation can be employed from a complex domain to the real domain. For example, the real and imaginary parts of the input data 502 (of size N×M× L) can be separated and then concatenated together to generate an input data of size 2N×M× L which only has real values. The concatenation can happen in other dimensions as well. In another example, the system 500 may virtually extend the channel matrix with their conjugate and then use inverse fast Fourier transform (IFFT) to transform the extended data. The results, for instance, will be real numbers and can be used with neural networks.
   Some of the tensors may have a reduced dimensionality. For instance, the second and/or third dimension 3D tensors described above may have value 1 reducing to 1D or 2D tensors.

Considerations regarding the training and/or inference phases:
a. The input data 502 can be collected at the UE subsystem 500a and then depending on where the model will be trained, it can be used at the UE subsystem 500a or transferred to the network subsystem 500b.
b. The neural network weights are initialized randomly for training. The neural network weights can be changed during the training phase in a way that reduces the loss function. The neural network weights can be fixed during the inference time.
c. The tensors of the quantization codebooks may not be fixed and they can be determined during the training procedure. They can also be fixed during the inference phase.
d. It can be considered that the network subsystem 500b quantization codebook 532 is the same as the UE subsystem 500a quantization codebook 510. For instance, after the model is trained, there may be one quantization codebook which will be used by both subsystem 500a and subsystem 500b. For example, assuming that the complete model has been trained at the network subsystem 500b, the resulted quantization codebook can be transferred to the UE subsystem 500a along the other weights of the neural network blocks that are used for the UE subsystem 500a. If the training phase happens at the UE subsystem 500a, the quantization codebook 510 and the weights of the network subsystem 500b blocks will be transferred to the network subsystem 500b.

Considerations regarding the network loss function:
a. One example of the objective function is to minimize the mean square error between the input data 502 and the output data 546 (reconstructed data).
b. One method to have an end-to-end differentiable loss function is to consider that input 525 is equal to the output 508 and input 526 is equal to output 518 in the backpropagation phase.

Considerations regarding communication requirements:
a. If the model trained at the network subsystem 500b, some mechanisms for exchange of some information between the UE subsystem 500a and the network subsystem 500b can be provided, such as: A method to send input data (e.g., channel measurements (or any of its desired transformation)) to the network subsystem 500b. A method to send the final neural network weights of the UE subsystem 500a side to the UE subsystem 500a. A method to send a quantization codebook (e.g., learned codebook) to the UE subsystem 500a. A method to send the number of quantization levels, Q, of the quantizer module 520 to the UE subsystem 500a. A method to transmit output 514 and output 522 (and/or representations thereof) to the network subsystem 500b.
b. If the model is trained at the UE subsystem 500a, some mechanisms can be provided for exchange of some information between the UE subsystem 500a and the network subsystem 500b, such as: A method to send the final neural network weights of the network subsystem 500b side to the network subsystem 500b. A method to send a quantization codebook (e.g., learned codebook) to the network subsystem 500b. A method to transmit output 514 and output 522 (and/or representations thereof) to the network subsystem 500b.

It should be noted that in at least some implementations, the UE subsystem 500a is to have enough computational resources to perform the training. Further, the UE subsystem 500a may have access to sufficient training samples of an environment to create a model with appropriate generalizations (e.g., in scenarios where the same model is to be used by different UEs). In at least some examples, a UE performing training may be a high-performance UE and/or artificial intelligence/machine learning (AI/ML) model training source with capabilities for model training (e.g., sufficient computational and/or memory resources) and model transfer to a gNB (e.g., via Uu interface) and/or a UE (e.g., via sidelink channels).

With reference to monitoring the performance of a two-sided model, one common way used to determine that the model is not performing appropriately is to compare the output of the gNB side with what should have been fed back to it or the input at the UE side. For example, if the output should be H^{k}[n,m,l], one scheme could be that the UE sends the correct H^{k}[n,m,l] to the gNB (e.g., using a conventional feedback mechanism). Then the gNB compares the Ĥ^{k}[n,m,l] that it has estimated using the two-sided model and the correct H^{k}[n,m,l] which it has received using the second mechanism. If the difference between them is large, then the gNB can decide that the model is not well-calibrated and initiate the update process.

However, a challenge with this method is that transmission of the correct H^{k}[n,m,l] is not a straightforward task (even using a conventional feedback scheme) and new schemes are needed. Additionally, the signaling overhead needed for transmission of the correct data may also be an issue. An alternative is that the gNB feedback what it has estimated to the UE, for example using some modified conventional approaches, and then the UE compares the gNB estimated values with the actual values (e.g., the input data to the UE side of the model). If the difference is larger than a threshold, the UE determines that the model is not performing well. However, this also shares the same drawbacks of the previous scheme with the need for design of new schemes for transmission of the gNB estimated output to the UE and signaling overhead.

With reference to training a two-sided model, a reason for separate model training is that the first and second nodes want to use a model that they have designed and optimized themselves, and not just run a model that is provided by another vendor. This also gives protection on the design of the NN models of each node since it does not need to share it with another party or entity. Several methods can be used for separate training of a two-sided model. For example, the separate training of a two-sided model can start by training the model at the first node (e.g., the UE side), and then training the model at the second node (e.g., the gNB side), which is referred to herein as first-node-first training. Alternatively, training the two-sided model can start by first training at the second node (e.g. the gNB side) and then training the model at the first node (e.g., the UE side), which is referred to herein as the second-node-first training. There may be other training alternatives as well.

The concept of the first-node-first training is that the first node (e.g. the UE) first trains the encoder part by assuming a model for the decoder part. Note that the assumed decoder part might be different from the actual model of the actual decoder part at the second node. Also note that the training dataset at the first node might be collected and/or measured by the first node, or received from other nodes. After completion of the training, the first node generates a dataset of samples from the output of the encoder (e.g., which is also considered as the input of the decoder) and the expected output of the decoder. Sending this dataset to the second node (e.g., the gNB), the second node can train the decoder part based on the model structure determined by itself. Another method for first-node-first separate training can be that, instead of generating a dataset for the second node, the first node transmits information regarding the trained “assumed decoder” so that the second node can train the actual decoder to match the input/output relation of the assumed decoder.

A similar procedure can be used for the second-node-first training, where the second node (e.g. the gNB) first trains the decoder part by assuming a model for the encoder part. Note that the assumed encoder part might be different from the actual model of the actual encoder part at the first node. Also note that the training dataset at the second node might be collected and/or measured by the second node, or received from other nodes. After completion of the training, the second node generates a dataset of samples from the nominal input of the assumed encoder (e.g., which is also considered as the input of the encoder) and the output of the assumed encoder (e.g., which is also considered as the input of the encoder, and which can be considered as the expected output of the encoder). In sending this dataset to the first node (e.g., the UE), the first node can train the encoder part based on the model structure determined by itself.

Alternatively, instead of generating a dataset for the first node, the second node transmits information regarding the trained “assumed encoder” to the first node, so that the first node can then train the actual encoder to match the input/output relation of the assumed encoder. One shortcoming of the scheme described above is that, for example, in the first-node-first training method, the first node designs its encoder part based on the assumption that the “actual decoder” would perform similar to the “assumed decoder”. But, after training the “actual decoder” at the second node, it might not exactly behave similar to the “assumed decoder”, which can be due to many reasons such as a lack of training samples, overfitting, and difference in the NN structure of the “assumed decoder” and the “actual decoder”. A similar issue exists due to the possible difference between the “assumed encoder” and “actual encoder” of the second-node-first training approach. In aspects of the techniques described herein, advantage this inconsistency in the sperate training of a two-sided model is removed.

In aspects of the techniques described for two-sided model training, the described techniques are directed to separate training and model updates, where the NN modules of a first node (e.g., a UE) and a second node (e.g., a gNB) are trained in different training sessions, without forward or backpropagation paths between the UE and the gNB. Notably, an advantage of the separate training is that the first and the second nodes do not need to be aware of the internal structure of the NN module of the other side. In one or more implementations of a two-sided model, the described techniques train and/or update a two-sided model in separate training loops, and as described above, removes the inconsistency in the separate training of a two-sided model.

Further, as described above, the parameters of a two-sided model are trained before it can effectively feedback the information to the gNB. The model is trained by presenting a set of input and desired output to the model (the training data set), which the model uses to find the statistics of the input and the input/output relation, and capture that in the parameters of the model. The trained model can be used as long as the statistics of the input and/or the input/output relation remains similar to what has been presented to the model during the training time, or the model could be generalized well to the new situation. In other aspects, the described techniques are directed to how the system of a two-sided model (e.g., gNB and/or UE) determines that the model is not performing appropriately. For example, the quantity of data and signaling needed to implement a monitoring procedure is taken into consideration for the techniques.

With reference to model monitoring in a two-sided model, the M is used to refer to the complete model while Mₑ and M_{d} are referring to the UE side and gNB side of the model, respectively. Note, that the proposed implementations are also applicable to the scenario where the roles of the UE and gNB are reversed with a two-sided model, i.e., the encoder, Me, model is performed at the gNB and the decoder, M_{d}, model is performed at the UE.

Assuming that the two-sided model has been trained already (e.g., at the gNB, network node, or UE). Several implementations can be considered for a system of a two-sided model system, such as a) a group of UEs use the same model (i.e., same Mₑ and M_{d} are used for encoding and decoding of the input data, b) the M_{d} module at the gNB is the same for a group of UEs, but each UE in that group can have different UE part, i.e., Me. and c) each UEs has its own model, i.e., one pair of Mₑ and M_{d} for each users. In all cases, we assume that the parameters of the UE side (i.e., Mₑ) has been known to or transmitted to each UE; and the parameters of the gNB side (i.e., M_{d}) has been known to or transmitted to the gNB.

It is expected that the two-sided model has satisfactory results after training. However, the performance of the trained model can be reduced if the statistics of the input or the input/output relation changes in time. Consider a two-sided model where there are K first-nodes (e.g., UEs) having the encoder part and T second-nodes (e.g., gNBs) having the decoder part. The two-sided model is assumed to be trained using a two-sided model. For example, the i^{th} first-node determines a NN structure for its own encoder part ( [symbol] ₑᵢ) and the also assume a NN structure for the decoder part ( [symbol] _{di}). Further the i^{th} first-node has access to the i^{th} training data set Dᵢ{ [symbol] xₗ,oₗ [symbol] , l=1, 2, . . . , N} (where xₗ is the input of the two-sided model and oₗ is the desired output of the two-sided model). This training dataset (e.g., CSI dataset) can be collected and/or measured from the environment, or received at the i^{th} first-node from another node.

The i^{th} first-node then uses training data set Dᵢ to train [symbol] ₑᵢ and [symbol] _{di}, referred to as the local two-sided model. The i^{th} first-node then uses the trained two-sided model to generate a training dataset

$${\vec{D}}_{i}^{j} = \{ 〈 {z}_{l} , {o}_{l} 〉 , l = 1 , 2 , … , M \}$$

where zₗ= [symbol] ₑᵢ(xₗ), which represents the latent representation of input data xₗ based on the trained model [symbol] ₑᵢ. As step 1, xₗ is the input of the two-sided model and oₗ is the desired output of the two-sided model. They can be the same samples of set Dᵢ or different samples.

The i^{th} first-node then sends

$${\vec{D}}_{i}^{j}$$

to j^{th} second-node. The j^{th} second-node receives

$${\vec{D}}_{i}^{j}$$

from all of the first nodes and creates training set \vec{D}^{j} using all of these data sets. The j^{th} second node determines a NN structure for its own decoder part ( [symbol] _{dj}). The j^{th} second-node uses training data set \vec{D}^{j} to train [symbol] _{dj} (i.e., zₗ acts as the input of the input of [symbol] _{dj} and oₗ acts as the expected output of the model).

Alternatively, instead of generating training dataset

$${\vec{D}}_{i}^{j} = \{ 〈 {z}_{l} , {o}_{l} 〉 , l = 1 , 2 , … , M \}$$

by the i^{th} first-node, the i^{th} first node may send information regarding [symbol] _{di} along with a set of latent representations constructed by [symbol] ₑᵢ, i.e., {zₗ= [symbol] ₑᵢ(xₗ), l=1, 2, . . . , M} to the j^{th} second-node. The second node can use the set of all latent representations from all of the first nodes and their [symbol] _{di} to train [symbol] _{dj}. At this stage, the two sided model has three types of trained models, a [symbol] ₑᵢ encoder at the first node side, a [symbol] _{dj} decoder at the second node side, and [symbol] _{di} is how the i^{th} first-node understands the actual decoder at the second node works.

In aspects of the described two-sided model performance monitoring, the monitoring techniques take benefit of [symbol] _{di}. Specifically, for a given sample (an input and expected output pair) the i^{th} first-node can first find the latent representation of the input data, and then use its own local version of the decoder (i.e., [symbol] _{di}) to generate the output. This output should be similar to the expected output. Also, it should have a high similarity to the actual output of the second nodes, as [symbol] _{dj} is also trained to generate an output similar to the expected output.

In one or more implementations, a monitoring technique is to send one or a set of “expected outputs” (associated with one or a set of input data), to the second node and then determine the similarity between the expected outputs and the outputs of the [symbol] _{dj} generated from the latent representations, which correspond to the associated input data, or a set of input data. In the case of a high difference (or average difference), the system will raise a flag for a possible issue in the trained model and the possible need for a model update. Note that there are several ways to compute the difference between the output and the expected output, such as by Euclidian distance, cosine similarity, and others. The decision about which of them to use is application dependent. The main issue of previous monitoring schemes is the overhead of sending the “expected output” to the second node and also the possible latency that the decision is happening at the second node and not at the first node.

In one or more implementations, a technique utilizes a local decoder after separate training, where instead of [symbol] _{dj}, the [symbol] _{di} is used. More precisely, the performance of the system is monitored by monitoring the difference between one or a set of “expected outputs” (associated with one or a set of input data), and outputs of the [symbol] _{di} generated from the latent representations which correspond to the associated input data or the set of input data. In the case of a high difference (or average difference), the system will raise a flag for a possible issue in the trained model and a possible need for a model update. Note that since there is no need for transmission of the “expected output” to the second node, this proposed technique has a lower overhead compared to the first described technique. Also, the monitoring is performed at the first node, which incurs less latency. Note also that in some cases the expected output might be the input data (e.g., the goal is reconstruction of the input).

In an implementation scenario, the local decoder might be different from the actual decoder at the second node. Therefore, the decisions that the monitoring scheme makes based on [symbol] _{di} might have a lower accuracy compared to the decisions made based on the actual output at the second node. Such differences can occur due to different reasons, such as when the model structure of the local decoder and the actual decoder are not the same, or when the model that the second node uses to generate [symbol] _{dj} is different from the samples available at the i^{th} first-node (e.g., which may be due to the difference in the data than different first node observers).

In one or more implementations, a technique utilizes an updated local decoder based on samples fed back from the second node, where to improve the performance, each of the second nodes transmit back information to each of the first nodes, and characterize its developed [symbol] _{dj}. This characterization can be by sending some samples showing the input/output of [symbol] _{dj} or sending [symbol] _{dj} directly to the first node. The first node can then use this information to update the local decoder model, [symbol] _{di}, to have a better match with the actual decoders.

For example, after training of [symbol] _{di}, each of the second nodes (for example the j^{th} second-node) constructs and transmits

$${\overleftarrow{D}}_{i}^{j} = \{ 〈 {z}_{l} , {\hat{o}}_{l} = {ℳ}_{di} ( {z}_{l} ) 〉 , l = 1 , 2 , … , L \}$$

to the i^{th} first node. Note that the samples zₗ in could be the same or a subset of samples in \vec{D}ᵢ and can include some samples zₗ not included in \vec{D}ᵢ. Then the i^{th} first node receives from all of the second nodes and creates the combined dataset \vec{D}ᵢ, which it uses to train the local copy of the decoder (i.e., [symbol] _{di}, and the process continues as before).

Furthermore, note that after updating [symbol] _{di}, the first node can try to update [symbol] ₑᵢ without changing [symbol] _{di}. Having the updated [symbol] ₑᵢ, the first node may generate another training dataset for the second nodes as before the is iterated as the update process to improve the accuracy of the two sided model, as well as the similarity between the local and the actual decoder models. The iteration of the updated [symbol] _{di} can then be used for the monitoring scheme presented above. Noting that now the local decoder is more aligned with the actual decoder, which reduces the possibility of a mismatch between the output of the local decoder and the actual decoder. This will increase the accuracy of the monitoring scheme.

In alternate one or more implementations without a local decoder, but a construct from a set of samples received from the gNB side, a technique involves the first node not having a local decoder. In other words, the system is a two-sided model with an encoder model at the first node and the decoder model at the second node. In this scenario, there is not a local decoder model to be used for monitoring. In such cases, assume that the j^{th} second node transmits information to each of i^{th} first nodes, and characterization develops [symbol] _{dj}. This characterization can be by sending some samples showing the input/output of [symbol] _{dj}

$$( e . g . , {\overleftarrow{D}}_{i}^{j} = \{ 〈 {z}_{l} , {\hat{o}}_{l} = {ℳ}_{di} ( {z}_{l} ) 〉 , l = 1 , 2 , … , L \} ) .$$

Note that the samples zₗ in can be some samples that the second node receives from the i^{th} first-node or also other first nodes. Another alternative could be to send [symbol] _{dj} directly to the first node.

The first node then can use this information to construct a local decoder model, [symbol] _{di}. Having the local decoder model, the first node can monitor the model by monitoring the difference between one or a set of “expected outputs” (associated with one or a set of input data), and outputs of the [symbol] _{di} generated from the encoder model which corresponds to the associated input data or the set of input data. In the case of a high difference (or average difference), the system will raise a flag for a possible issue in the trained model and a possible need for a model update. Note that the level of difference that indicates the possible issue may be based on a threshold value which is set by another node in the network, which is also valid for all of the described one or more implementations.

With reference to training a two-sided model with K first-nodes and a single second node as related to a first-node-first method, the training procedure includes the i^{th} first node determines a NN structure for its own encoder part ( [symbol] ₑ) and also assumes a NN structure for the decoder part ( [symbol] _{di}). Assuming that the i^{th} first node has access to the i^{th} training data set Dᵢ={ [symbol] xₗ, oₗ [symbol] , l=1, 2, . . . , N}(where xₗ is the input of the two-sided model and oₗ is the desired output of the two-sided model). This training dataset (e.g., CSI dataset) can be collected and/or measured from the environment or received at the i^{th} first-node from another node. Then, the i^{th} first node uses training data set Dᵢ to train [symbol] ₑᵢ and [symbol] _{di}, referred to as the local two-sided model. Then, the i^{th} first-node uses the trained two-sided model to generate training dataset \vec{D}ᵢ={ [symbol] zₗ, oₗ [symbol] , l=1, 2, . . . , M} where zₗ= [symbol] ₑᵢ(xₗ), which represents the latent representation of input data xₗ based on the trained model [symbol] ₑᵢ. As step 1, xₗ is the input of the two-sided model and oₗ is the desired output of the two-sided model. They can be the same samples of a set Dᵢ or different samples.

The i^{th} first-node then sends \vec{D}ᵢ to the second node, and the second node receives \vec{D}ᵢ from all of the first nodes and creates training set \vec{D} using all of these data sets. The second node determines a NN structure for its own decoder part ( [symbol] _{d}). The second node uses training data set \vec{D} to train [symbol] _{d}, i.e., zₗ acts as the input of the input of [symbol] _{d} and oₗ acts as the expected output of the model. Alternatively, instead of generating training dataset \vec{D}_{L} by the i^{th} first node, the i^{th} first node may send information regarding [symbol] _{di} along a set of latent representations constructed by [symbol] ₑᵢ (i.e., {zₗ= [symbol] ₑᵢ(xₗ), l=1, 2, . . . , M} to the second node). The second node can use the set of all latent representations from all of the first nodes and their [symbol] _{di} to train [symbol] _{d}.

Having a trained decoder part, [symbol] _{d}, the second node constructs K dataset \vec{D}ᵢ={ [symbol] zₗ, ôₗ= [symbol] _{d}(zₗ) [symbol] , l=1, 2, . . . , L}. Note that the samples zₗ in could be the same or a subset of samples in \vec{D}ᵢ and can be some samples zₗ not included in \vec{D}ᵢ. The second node transmits \vec{D}ᵢ to the i^{th} first node, where receiving \vec{D}ᵢ, the first node can train or retrain the local decoder part [symbol] _{di} (i.e., zₗ acts as the input of the input of [symbol] _{di} and \vec{o}ⱼ acts as the expected output of the [symbol] _{di}). Note that the goal of this step is to update the “local decoder part” (i.e., [symbol] _{di} of the i^{th} first node to act as similar as possible to the decoder part of the second node at least for the input samples observable at the i^{th} first node.

Alternatively, instead of generating training dataset \vec{D}ᵢ by the second node, the second node may send information regarding [symbol] _{d} to the first node. The first node can use the received [symbol] _{d} along the latent representation of the input data generated using [symbol] ₑᵢ to retrain the [symbol] _{di}. After updating [symbol] _{di}, the i^{th} first node fixes the parameters of the [symbol] _{di} and retrains the local two-sided model ( [symbol] ₑᵢ and [symbol] _{di}) using dataset Dᵢ. Dataset Dᵢ could be the same dataset as the initial one or can be a dataset constructed from new collected, measured, and/or received samples. Having the updated version of [symbol] ₑᵢ, the i^{th} first-node again sends required information as described before (e.g., updated \vec{D}ᵢ to the second node).

The process continues at the second node by combining the dataset from all first nodes and retraining the decoder part. The process can be reiterated. The training process can be completed based on different conditions, as a number of communication rounds between the first and the second round, time, the accuracy/loss of the training of each of the NN modules (i.e., for example the loss of the decoder part). Note that the above-mentioned procedure can also be used in scenarios where there are different datasets at different first nodes and also when the NN structure assumed for the encoder part is different, and also when the NN structure of the local decoder parts are different from the NN structure of the actual decoder at the second node. Notably, this procedure helps reduce the effect of such imbalance between different nodes and assumptions on the final performance of the trained two-sided model.

With reference to training a two-sided model with reference to multiple first-nodes, multiple second-nodes, and implementation extension can be that instead of one decoder part, there are multiple decoder parts at different second nodes, such as in a scenario where there are K first-nodes and T second-nodes. A similar procedure as described above can be used in this case, with a difference being that each of the first nodes sends their information described above (e.g. \vec{D}ᵢ) to all of the second nodes. Note that it is possible that the first nodes send different datasets to different second nodes.

Then each of the second nodes, for example the j^{th} second node as before, combine all received data to a set \vec{D}^{j} and train its [symbol] _{dj} using the constructed dataset. Further, it constructs the required information for each of the first nodes based on the trained version of [symbol] _{dj}. For example, the j^{th} second node generates and transmits

$${\overleftarrow{D}}_{i}^{j} = \{ 〈 {z}_{l} , {\hat{o}}_{l} = {ℳ}_{di} ( {z}_{l} ) 〉 , l = 1 , 2 , … , L \}$$

to the i^{th} first node. Note that the samples zₗ in can be the same or a subset of samples in \vec{D}ᵢ and can include some samples zₗ not included in \vec{D}ᵢ. Then the i^{th} first node receives all from all second nodes and creates the combined dataset Dᵢ, which it trains using the local copy of the decoder (i.e., [symbol] _{di}) and the process continues as before. The training process can be completed based on different conditions, as a number of communication rounds between the first and the second round, time, the accuracy/loss of the training of each of the NN modules (i.e., for example the loss of the decoder part).

The above discussions generally follow a first-node-first scheme. With reference to training a two-sided model using a second-node-first method for multiple first-nodes, multiple second-nodes, a similar idea can be used for the second-node-first method. This is outlined below considering the existence of K first-nodes and T second-nodes. The j^{th} second node determines a NN structure for its own encoder part ( [symbol] _{dj}) and then also assumes a NN structure for the decoder part ( [symbol] ₑⱼ). Further the j^{th} first node is assumed to have access to the j^{th} training data set Dⱼ={ [symbol] xₗ,oₗ [symbol] , l=1, 2, . . . N} (where xₗ is the input of the two-sided model and oₗ is the desired output of the two-sided model). This training dataset (e.g., CSI dataset) can be collected and/or measured from the environment, or received at the j^{th} second node from another node (e.g., from the first nodes). The j^{th} second node then uses training data set Dⱼ to train [symbol] _{dj} and [symbol] ₑᵢ, referred to as the local two-sided model.

The j^{th} second-node then uses the trained local two-sided model to generate training dataset

$${\overleftarrow{D}}_{i}^{j} = \{ 〈 {x}_{l} , {z}_{l} = {\hat{ℳ}}_{e j} ( {x}_{l} ) 〉 , l = 1 , 2 , … , L \} ,$$

where zₗ represents the latent representation of input data xⱼ based on the trained local model of encoder [symbol] ₑⱼ. The samples in

$${\overleftarrow{D}}_{i}^{j}$$

can be the same, a subset of, or different samples of set Dⱼ. The j^{th} second node then sends

$${\overleftarrow{D}}_{i}^{j}$$

to the i^{th} first node. The i^{th} first node receives

$${\overleftarrow{D}}_{i}^{j}$$

from all of the second nodes and creates a combined training set \vec{D}ᵢ using all of these data sets. The i^{th} first node determines a NN structure for its own encode part ( [symbol] ₑᵢ). The i^{th} first-node uses training data set \vec{D}ᵢ to train [symbol] ₑᵢ (i.e., xₗ acts as the input of the input of [symbol] ₑᵢ and zₗ acts as the expected output of the encoder model).

Alternatively, instead of generating training dataset

$${\overleftarrow{D}}_{i}^{j}$$

by the j^{th} second node, the j^{th} second node may send information regarding [symbol] ₑⱼ and in some cases also some input vectors xₗ to the first nodes. The first nodes can use the set of all input samples along all [symbol] ₑⱼ to train [symbol] ^{ei}. Having a trained encoder part, [symbol] ₑᵢ, the i^{th} first node constructs T datasets

$${\vec{D}}_{i}^{j} = \{ 〈 {x}_{l} , {\hat{z}}_{l} = {ℳ}_{e i} ( {x}_{l} ) 〉 , l = 1 , 2 , … , L \} .$$

Note that the samples xₗ in can be the same or subset of samples in

$${\overleftarrow{D}}_{i}^{j}$$

and can include some samples zₗ not included in \vec{D}ᵢ.

The i^{th} first-node transmits

$${\vec{D}}_{i}^{j}$$

to the j^{th} second-node, which receives

$${\vec{D}}_{i}^{j}$$

from all of the first nodes and creates the combined dataset \vec{D}^{j}, which it uses to train the local copy of the encoder [symbol] ₑⱼ (i.e., xₜ acts as the input of the input of [symbol] ₑⱼ and \hat{z}ⱼ acts as the expected output of the [symbol] ₑⱼ). Note that the goal of this step is to update the “local encoder part” (i.e., [symbol] ₑⱼ of the j^{th} second node to act as similar as possible to the average encoder part of the first nodes at least for the input samples observable in \vec{D}ⱼ).

Alternatively, instead of generating the training dataset

$${\vec{D}}_{i}^{j}$$

by the i^{th} first node, the i^{th} first node may send information regarding [symbol] ₑⱼ to the second nodes. The second nodes can use the received [symbol] ₑⱼ along the sample input data to retrain the [symbol] ₑⱼ. After updating [symbol] ₑⱼ, the j^{th} second node fixes the parameters of the [symbol] ₑⱼ and retrains the local two-sided model ( [symbol] ₑⱼ and [symbol] _{dj}) using dataset Dⱼ. The dataset Dⱼ can be the same dataset as the initial one or can be a dataset constructed from new collected, measured, and/or received samples. Also having the updated version of [symbol] ₑⱼ, the j^{th} second node again sends required information as described before (e.g., updated

$${\overleftarrow{D}}_{i}^{j}$$

to the i^{th} first-node). The process continues at the first nodes by combining the dataset from all second nodes and retraining the encoder part. The process is reiterated, and the training process can be completed based on different conditions, such as a number of communication rounds between the first and the second round, time, and/or the accuracy/loss of the training of each of the NN modules (i.e., for example the loss of the decoder part).

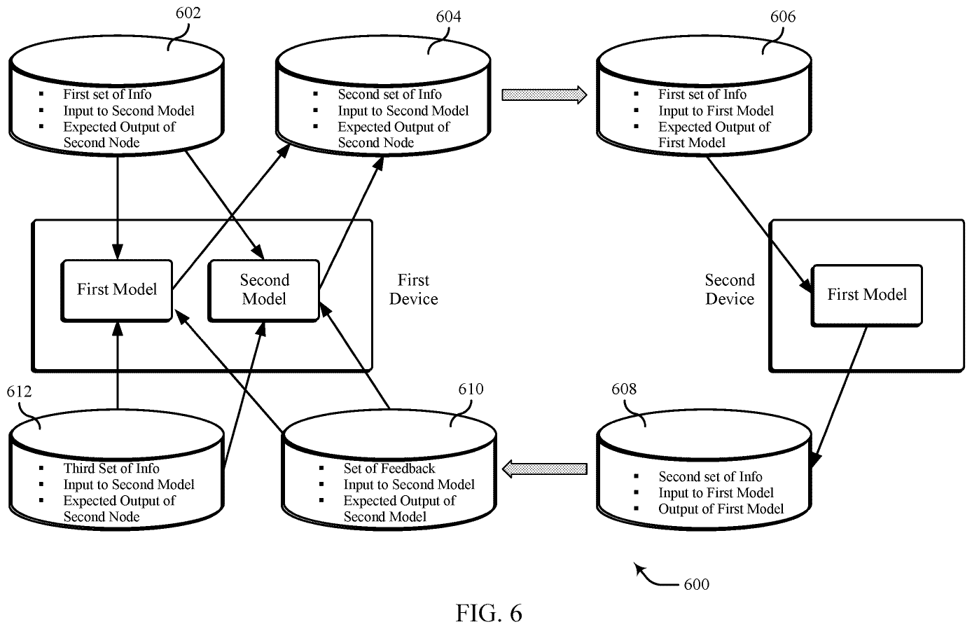

FIG. 6 illustrates an example system 600 of a two-sided model and training for performance monitoring, as related to two-sided model training in accordance with aspects of the present disclosure. In this example system 600, a first set of information 602 is used for training this two-sided model, and includes an input to the second model and an expected output of the second node. A second set of information 604 includes an input to the second model and an expected output of the second node. This second set of information 604 contributes to a “first data set” input to the first model of the second device. The second device uses the first set of information 606 to train its first model, and the second device generates a second set of information 608 as an output which is feedback to the first device. The set of feedback 610 from second device is used to train the second model of the first device. The now updated second model at the first device utilizes a third set of information 612 to update the first model of the first device. This provides a more accurate output from a UE (e.g., first device) and the second device (e.g., a gNB) is better matched to the first device

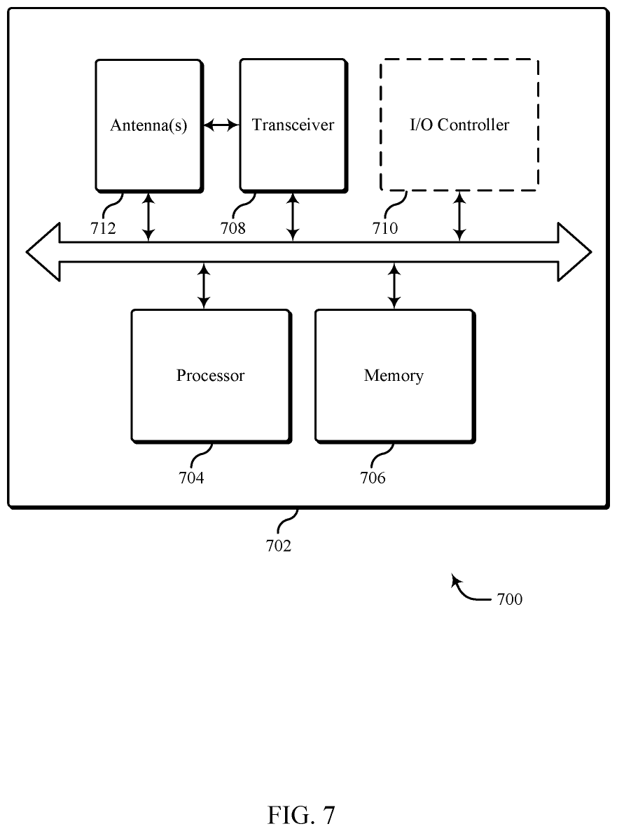

FIG. 7 illustrates an example of a block diagram 700 of a device 702 that supports two-sided model training in accordance with aspects of the present disclosure. The device 702 may be an example of a UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for determining a first set of parameters characterizing an encoder model of the first device based at least in part on a first set of information; determining a second set of parameters characterizing a decoder model of the first device based at least in part on the first set of information; transmitting a second set of information to at least one second device, the second set of information usable to determine a decoder of the second device, the second set of information determined based on at least one of the first set of parameters or the second set of parameters; receiving, from the second device, feedback information representing the decoder of the second device; and updating the second set of parameters characterizing the decoder model of the first device based at least in part on the feedback information representing the decoder of the second device.

Additionally, the processor 704 may be configured as or otherwise support any one or combination of the method further comprising updating the first set of parameters characterizing the encoder model of the first device based at least in part on the update of the second set of parameters and a third set of information. A third set of information includes a set of samples representing at least an input and an expected output of a model. The method further comprising: updating the first set of parameters characterizing the encoder model of the first device based at least in part on the third set of information; and wherein a serial concatenation of the encoder model based on the updated first set of parameters and the updated decoder model generates approximately similar input and output data pairs at least for the set of samples of the third set of information. The method further comprising determining to repeat an update; and performing the update by iterating at least: transmitting, to the second device, an updated second set of information that is based on at least one of an updated first set of parameters or an updated second set of parameters; receiving, from the second device, the feedback information representing the decoder of the second device; repeating the update of the second set of parameters characterizing the decoder model based at least in part on the feedback information representing the decoder of the second device; and repeating the update of the first set of parameters characterizing the encoder model of the first device based at least in part on the update of the second set of parameters and a third set of information. The method further comprising stopping an iterative update based at least in part on an update procedure exceeding a threshold amount of time, a training loss of the encoder model or the decoder model is less than a threshold, or if the first device is directed to stop the iterative update. A two-sided model has a UE side and a network side; and the first device is a first network node at the UE side, and the at least one second device is a second network node at the network side. The first set of information includes data samples representing at least an input and an expected output of a two-sided model that includes the encoder model and a decoder model of the first device. The first set of information and output data of the two-sided model are based at least in part on CSI. The method further comprising determining a latent representation of the first set of information based at least in part on the encoder model; and generating the expected output based at least in part on the latent representation and the decoder model. The first set of parameters and the second set of parameters are utilized to determine NN parameters of one or more NN modules associated with the encoder model and the decoder model. The second set of information includes data samples representing at least one of an input and an expected output of the decoder model. The input of the decoder model is an output of the encoder model. The second set of information includes at least characterizing information of the decoder model. The feedback information includes samples representing at least one of an input and an expected output of the decoder model. The decoder model generates approximately similar input and output data pairs at least for samples of the feedback information based at least in part on the second set of parameters being updated to characterize the decoder model. The method further comprising transmitting an indication to at least one of the second device or a network entity to stop iterative training of a two-sided model based at least in part on one or more update conditions. The first set of information is at least one of collected at the first device, measured by the first device, or received from a network entity. The first set of information includes at least one of a structure or weights of at least one neural network model.

Additionally, or alternatively, the device 702, in accordance with examples as disclosed herein, may include a processor, and a memory coupled with the processor, the processor configured to cause the apparatus to: determine a first set of parameters characterizing an encoder model of the apparatus based at least in part on a first set of information; determine a second set of parameters characterizing a decoder model of the apparatus based at least in part on the first set of information; transmit a second set of information to at least one second device, the second set of information usable to determine a decoder of the second device, the second set of information determined based on at least one of the first set of parameters or the second set of parameters; receive, from the second device, feedback information representing the decoder of the second device; and update the second set of parameters characterizing the decoder model of the apparatus based at least in part on the feedback information representing the decoder of the second device.

Additionally, the wireless communication at the device 702 may include any one or combination of the processor is configured to cause the apparatus to update the first set of parameters characterizing the encoder model of the apparatus based at least in part on the update of the second set of parameters and a third set of information. A third set of information includes a set of samples representing at least an input and an expected output of a model. The processor is configured to cause the apparatus to update the first set of parameters characterizing the encoder model of the apparatus based at least in part on the third set of information; and a serial concatenation of the encoder model based on the updated first set of parameters and the updated decoder model generates approximately similar input and output data pairs at least for the set of samples of the third set of information. The processor is configured to cause the apparatus to: determine to repeat an update; and perform the update by iterating at least to: transmit, to the second device, an updated second set of information that is based on at least one of an updated first set of parameters or an updated second set of parameters; receive, from the second device, the feedback information representing the decoder of the second device; repeat the update of the second set of parameters characterizing the decoder model based at least in part on the feedback information representing the decoder of the second device; and repeat the update of the first set of parameters characterizing the encoder model of the apparatus based at least in part on the update of the second set of parameters and a third set of information. The processor is configured to cause the apparatus to stop an iterative update based at least in part on an update procedure exceeding a threshold amount of time, a training loss of the encoder model or the decoder model is less than a threshold, or if the apparatus is directed to stop the iterative update. A two-sided model has a UE side and a network side; and the apparatus is a first network node at the UE side, and the at least one second device is a second network node at the network side. The first set of information includes data samples representing at least an input and an expected output of a two-sided model that includes the encoder model and a decoder model of the apparatus. The first set of information and output data of the two-sided model are based at least in part on CSI. The processor is configured to cause the apparatus to: determine a latent representation of the first set of information based at least in part on the encoder model; and generate the expected output based at least in part on the latent representation and the decoder model. The first set of parameters and the second set of parameters are utilized to determine NN parameters of one or more NN modules associated with the encoder model and the decoder model. The second set of information includes data samples representing at least one of an input and an expected output of the decoder model. The input of the decoder model is an output of the encoder model. The second set of information includes at least characterizing information of the decoder model. The feedback information includes samples representing at least one of an input and an expected output of the decoder model. The decoder model generates approximately similar input and output data pairs at least for samples of the feedback information based at least in part on the second set of parameters being updated to characterize the decoder model. The processor is configured to cause the apparatus to communicate an indication to at least one of the second device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

For example, the processor 704 may support wireless communication at the device 702 in accordance with examples as disclosed herein. The processor 704 may be configured as or otherwise support a means for receiving a first set of information from at least one first device, the first set of information including at least characterizing information of an encoder model or a decoder model of the first device; determining a first set of parameters representing an encoder model of the second device based at least in part on the first set of information; and transmitting feedback information to the at least one first device to update parameters characterizing the encoder model at the first device, the feedback information being based on at least one of the encoder model of the second device or a second set of information.

Additionally, the processor 704 may be configured as or otherwise support any one or combination of the method further comprising determining to repeat an update; and performing the update by iterating at least: receiving the first set of information from the at least one first device; determining the first set of parameters representing the encoder model of the second device based at least in part on the first set of information; and transmitting the feedback information to the at least one first device to update the parameters characterizing the encoder model at the first device. A two-sided model has a user equipment (UE) side and a network side; and the second device is a first network node at the UE side, and the at least one first device is a second network node at the network side. The first set of information includes characterizing information of the encoder model of a two-sided model. The first set of information includes data samples representing at least an input and an expected output of the encoder model of a two-sided model. The first set of parameters are utilized to determine NN parameters of one or more NN modules associated with the encoder model. The first set of parameters are determined such that the encoder model generates approximately similar input and output data pairs at least for samples of the first set of information. A second set of information includes a set of samples representing at least an input to the encoder model of a two-sided model. The feedback information includes data samples representing at least an input and an output of the encoder model. The method further comprising stopping an iterative update based at least in part on an update procedure exceeding a threshold amount of time, a training loss of the decoder model or the encoder model is less than a threshold, or if the second device is directed to stop the iterative update. The method further comprising transmitting an indication to at least one of the first device or a network entity to stop iterative training of a two-sided model based at least in part on one or more update conditions. The first set of information is at least one of collected at the second device, measured by the second device, or received from a network entity. The first set of information includes at least one of a structure or weights of at least one neural network model.

Additionally, or alternatively, the device 702, in accordance with examples as disclosed herein, may include a processor, and a memory coupled with the processor, the processor configured to cause the apparatus to: receive a first set of information from at least one first device, the first set of information including at least characterizing information of an encoder model or a decoder model of the first device; determine a first set of parameters representing an encoder model of the apparatus based at least in part on the first set of information; and transmit feedback information to the at least one first device to update parameters characterizing the encoder model at the first device, the feedback information being based on at least one of the encoder model of the apparatus or a second set of information.

Additionally, the wireless communication at the device 702 may include any one or combination of the processor is configured to cause the apparatus to: determine to repeat an update; and perform the update by iterating at least to: receive the first set of information from the at least one first device; determine the first set of parameters representing the encoder model of the apparatus based at least in part on the first set of information; and transmit the feedback information to the at least one first device to update the parameters characterizing the encoder model at the first device. A two-sided model has a UE side and a network side; and the apparatus is a first network node at the UE side, and the at least one first device is a second network node at the network side. The first set of information includes characterizing information of the encoder model of a two-sided model. The first set of information includes data samples representing at least an input and an expected output of the encoder model of a two-sided model. The first set of parameters are utilized to determine NN parameters of one or more NN modules associated with the encoder model. The first set of parameters are determined such that the encoder model generates approximately similar input and output data pairs at least for samples of the first set of information. A second set of information includes a set of samples representing at least an input to the encoder model of a two-sided model. The feedback information includes data samples representing at least an input and an output of the encoder model. The processor is configured to cause the apparatus to stop an iterative update based at least in part on an update procedure exceeding a threshold amount of time, a training loss of the decoder model or the encoder model is less than a threshold, or if the apparatus is directed to stop the iterative update. The processor is configured to cause the apparatus to communicate an indication to at least one of the first device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

The processor 704 of the device 702, such as a UE 104, may support wireless communication in accordance with examples as disclosed herein. The processor 704 includes at least one controller coupled with at least one memory, and is configured to or operable to cause the processor to determine a first set of parameters characterizing an encoder model of a UE based at least in part on a first set of information; determine a second set of parameters characterizing a decoder model of the UE based at least in part on the first set of information; transmit a second set of information to at least one NE, the second set of information usable to determine a decoder of the NE, the second set of information determined based on at least one of the first set of parameters or the second set of parameters; receive, from the NE, feedback information representing the decoder of the NE; and update the second set of parameters characterizing the decoder model of the UE based at least in part on the feedback information representing the decoder of the NE.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

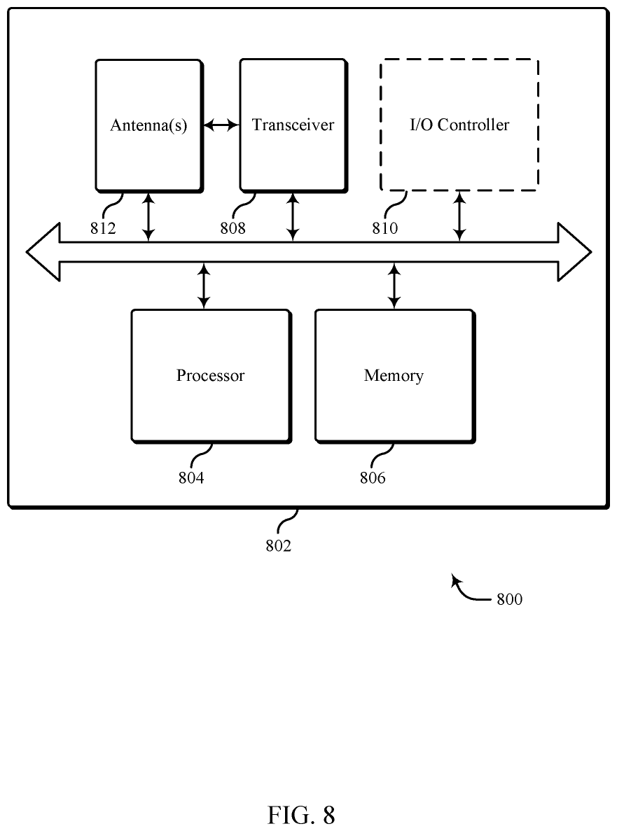

FIG. 8 illustrates an example of a block diagram 800 of a device 802 that supports two-sided model training in accordance with aspects of the present disclosure. The device 802 may be an example of a network entity 102 (e.g., a gNB) as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for receiving a first set of information from at least one first device, the first set of information including at least characterizing information of an encoder model or a decoder model of the first device; determining a first set of parameters representing a decoder model of the second device based at least in part on the first set of information; and transmitting feedback information to the at least one first device to update parameters characterizing the decoder model at the first device, the feedback information being based on at least one of the decoder model of the second device or a second set of information.

Additionally, the processor 804 may be configured as or otherwise support any one or combination of the method further comprising determining to repeat an update; and performing the update by iterating at least: receiving the first set of information from the at least one first device; determining the first set of parameters representing the decoder model of the second device based at least in part on the first set of information; and transmitting the feedback information to the at least one first device to update the parameters characterizing the decoder model at the first device. A two-sided model has a UE side and a network side; and the second device is a first network node at the network side, and the at least one first device is a second network node at the UE side. The first set of information includes the characterizing information of the decoder model of a two-sided model. The first set of information includes data samples representing at least an input and an expected output of the decoder model of a two-sided model. The first set of parameters are utilized to determine NN parameters of one or more NN modules associated with the decoder model. The first set of parameters are determined such that the decoder model generates approximately similar input and output data pairs at least for samples of the first set of information. A second set of information includes a set of samples representing at least an input to the decoder model of a two-sided model. The feedback information includes data samples representing at least an input and an output of the decoder model. The method further comprising stopping an iterative update based at least in part on an update procedure exceeding a threshold amount of time, a training loss of the encoder model or the decoder model is less than a threshold, or if the second device is directed to stop the iterative update. The method further comprising transmitting an indication to at least one of the first device or a network entity to stop iterative training of a two-sided model based at least in part on one or more update conditions. The first set of information is at least one of collected at the second device, measured by the second device, or received from a network entity. The first set of information includes at least one of a structure or weights of at least one neural network model.

Additionally, or alternatively, the device 802, in accordance with examples as disclosed herein, may include a processor, and a memory coupled with the processor, the processor configured to cause the apparatus to: receive a first set of information from at least one first device, the first set of information including at least characterizing information of an encoder model or a decoder model of the first device; determine a first set of parameters representing a decoder model of the apparatus based at least in part on the first set of information; and transmit feedback information to the at least one first device to update parameters characterizing the decoder model at the first device, the feedback information being based on at least one of the decoder model of the apparatus or a second set of information.

Additionally, the wireless communication at the device 802 may include any one or combination of the processor is configured to cause the apparatus to: determine to repeat an update; and perform the update by iterating at least to: receive the first set of information from the at least one first device; determine the first set of parameters representing the decoder model of the apparatus based at least in part on the first set of information; and transmit the feedback information to the at least one first device to update the parameters characterizing the decoder model at the first device. A two-sided model has a UE side and a network side; and the apparatus is a first network node at the network side, and the at least one first device is a second network node at the UE side. The first set of information includes the characterizing information of the decoder model of a two-sided model. The first set of information includes data samples representing at least an input and an expected output of the decoder model of a two-sided model. The first set of parameters are utilized to determine NN parameters of one or more NN modules associated with the decoder model. The first set of parameters are determined such that the decoder model generates approximately similar input and output data pairs at least for samples of the first set of information. A second set of information includes a set of samples representing at least an input to the decoder model of a two-sided model. The feedback information includes data samples representing at least an input and an output of the decoder model. The processor is configured to cause the apparatus to stop an iterative update based at least in part on an update procedure exceeding a threshold amount of time, a training loss of the encoder model or the decoder model is less than a threshold, or if the apparatus is directed to stop the iterative update. The processor is configured to cause the apparatus to communicate an indication to at least one of the first device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

For example, the processor 804 may support wireless communication at the device 802 in accordance with examples as disclosed herein. The processor 804 may be configured as or otherwise support a means for determining a first set of parameters characterizing an encoder model of the first device based at least in part on a first set of information; determining a second set of parameters characterizing a decoder model of the first device based at least in part on the first set of information; transmitting a second set of information to at least one second device, the second set of information usable to determine an encoder of the second device, the second set of information determined based on at least one of the first set of parameters or the second set of parameters; receiving, from the second device, feedback information representing the encoder of the second device; and updating the first set of parameters characterizing the encoder model of the first device based at least in part on the feedback information representing the encoder of the second device.

Additionally, the processor 804 may be configured as or otherwise support any one or combination of the method further comprising updating the second set of parameters characterizing the decoder model of the first device based at least in part on the update of the first set of parameters and a third set of information. A third set of information includes a set of samples representing at least an input and an expected output of a model. The method further comprising updating the second set of parameters characterizing the decoder model of the first device based at least in part on the third set of information; and wherein a serial concatenation of the decoder model based on the updated second set of parameters and the updated encoder model generates approximately similar input and output data pairs at least for the set of samples of the third set of information. The method further comprising determining to repeat an update; and performing the update by iterating at least: transmitting, to the second device, an updated second set of information that is based on at least one of an updated first set of parameters or an updated second set of parameters; receiving, from the second device, the feedback information representing the encoder of the second device; repeating the update of the first set of parameters characterizing the encoder model based at least in part on the feedback information representing the encoder of the second device; and repeating the update of the second set of parameters characterizing the decoder model of the first device based at least in part on the update of the first set of parameters and a third set of information. The method further comprising stopping an iterative update based at least in part on an update procedure exceeding a threshold amount of time, a training loss of the decoder model or the encoder model is less than a threshold, or if the first device is directed to stop the iterative update. A two-sided model has a user equipment (UE) side and a network side; and the first device is a first network node at the network side, and the at least one second device is a second network node at the UE side. The first set of information includes data samples representing at least an input and an expected output of a two-sided model that includes the decoder model and an encoder model of the first device. The first set of information and output data of the two-sided model are based at least in part on CSI. The method further comprising determining a latent representation of the first set of information based at least in part on the decoder model; and generating the expected output based at least in part on the latent representation and the encoder model. The first set of parameters and the second set of parameters are utilized to determine NN parameters of one or more NN modules associated with the encoder model and the decoder model. The second set of information includes data samples representing at least one of an input and an expected output of the encoder model. The input of the encoder model is an output of the decoder model. The second set of information includes at least characterizing information of the encoder model. The feedback information includes samples representing at least one of an input and an expected output of the encoder model. The encoder model generates approximately similar input and output data pairs at least for samples of the feedback information based at least in part on the first set of parameters being updated to characterize the encoder model. The method further comprising transmitting an indication to at least one of the second device or a network entity to stop iterative training of a two-sided model based at least in part on one or more update conditions. The first set of information is at least one of collected at the first device, measured by the first device, or received from a network entity. The first set of information includes at least one of a structure or weights of at least one neural network model.

Additionally, or alternatively, the device 802, in accordance with examples as disclosed herein, may include a processor, and a memory coupled with the processor, the processor configured to cause the apparatus to: determine a first set of parameters characterizing an encoder model of the apparatus based at least in part on a first set of information; determine a second set of parameters characterizing a decoder model of the apparatus based at least in part on the first set of information; transmit a second set of information to at least one second device, the second set of information usable to determine an encoder of the second device, the second set of information determined based on at least one of the first set of parameters or the second set of parameters; receive, from the second device, feedback information representing the encoder of the second device; and update the first set of parameters characterizing the encoder model of the apparatus based at least in part on the feedback information representing the encoder of the second device.

Additionally, the wireless communication at the device 802 may include any one or combination of the processor is configured to cause the apparatus to update the second set of parameters characterizing the decoder model of the apparatus based at least in part on the update of the first set of parameters and a third set of information. A third set of information includes a set of samples representing at least an input and an expected output of a model. The processor is configured to cause the apparatus to update the second set of parameters characterizing the decoder model of the apparatus based at least in part on the third set of information; and a serial concatenation of the decoder model based on the updated second set of parameters and the updated encoder model generates approximately similar input and output data pairs at least for the set of samples of the third set of information. The processor is configured to cause the apparatus to: determine to repeat an update; and perform the update by iterating at least to: transmit, to the second device, an updated second set of information that is based on at least one of an updated first set of parameters or an updated second set of parameters; receive, from the second device, the feedback information representing the encoder of the second device; repeat the update of the first set of parameters characterizing the encoder model based at least in part on the feedback information representing the encoder of the second device; and repeat the update of the second set of parameters characterizing the decoder model of the apparatus based at least in part on the update of the first set of parameters and a third set of information. The processor is configured to cause the apparatus to stop an iterative update based at least in part on an update procedure exceeding a threshold amount of time, a training loss of the decoder model or the encoder model is less than a threshold, or if the apparatus is directed to stop the iterative update. A two-sided model has a UE side and a network side; and the apparatus is a first network node at the network side, and the at least one second device is a second network node at the UE side. The first set of information includes data samples representing at least an input and an expected output of a two-sided model that includes the decoder model and an encoder model of the apparatus. The first set of information and output data of the two-sided model are based at least in part on CSI. The processor is configured to cause the apparatus to: determine a latent representation of the first set of information based at least in part on the decoder model; and generate the expected output based at least in part on the latent representation and the encoder model. The first set of parameters and the second set of parameters are utilized to determine NN parameters of one or more NN modules associated with the encoder model and the decoder model. The second set of information includes data samples representing at least one of an input and an expected output of the encoder model. The input of the encoder model is an output of the decoder model. The second set of information includes at least characterizing information of the encoder model. The feedback information includes samples representing at least one of an input and an expected output of the encoder model. The encoder model generates approximately similar input and output data pairs at least for samples of the feedback information based at least in part on the first set of parameters being updated to characterize the encoder model. The processor is configured to cause the apparatus to communicate an indication to at least one of the second device or a network entity to stop iterative training of a two-sided model based at least in part on one or more update conditions. The first set of information is at least one of collected at the apparatus, measured by the apparatus, or received from a network entity. The first set of information includes at least one of a structure or weights of at least one neural network model.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device 802. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

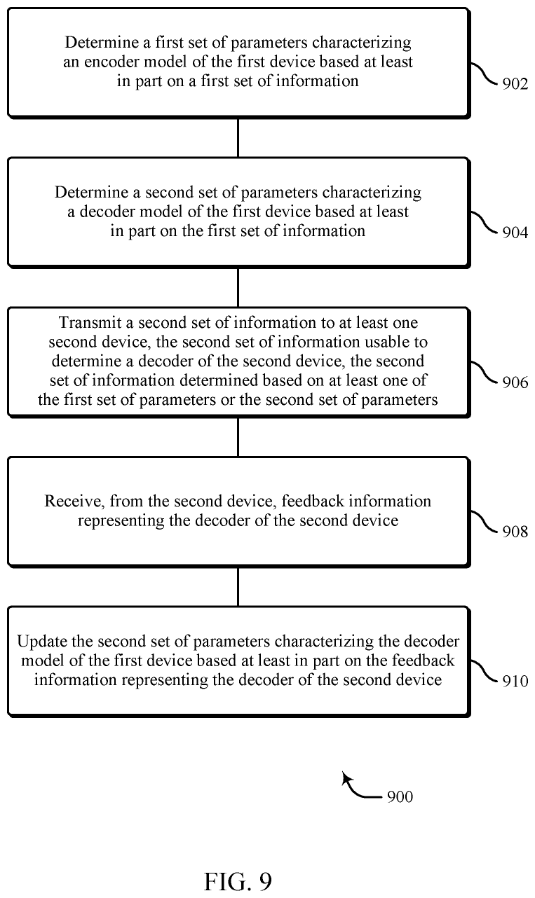

FIG. 9 illustrates a flowchart of a method 900 that supports two-sided model training in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include determining a first set of parameters characterizing an encoder model of the first device based at least in part on a first set of information. The operations of 902 may be performed in accordance with examples as described herein. In some implementations, aspects of the operations of 902 may be performed by a device as described with reference to FIG. 1.

At 904, the method may include determining a second set of parameters characterizing a decoder model of the first device based at least in part on the first set of information. The operations of 904 may be performed in accordance with examples as described herein. In some implementations, aspects of the operations of 904 may be performed by a device as described with reference to FIG. 1.

At 906, the method may include transmitting a second set of information to at least one second device, the second set of information usable to determine a decoder of the second device, the second set of information determined based on at least one of the first set of parameters or the second set of parameters. The operations of 906 may be performed in accordance with examples as described herein. In some implementations, aspects of the operations of 906 may be performed by a device as described with reference to FIG. 1.

At 908, the method may include receiving, from the second device, feedback information representing the decoder of the second device. The operations of 908 may be performed in accordance with examples as described herein. In some implementations, aspects of the operations of 908 may be performed by a device as described with reference to FIG. 1.

At 910, the method may include updating the second set of parameters characterizing the decoder model of the first device based at least in part on the feedback information representing the decoder of the second device. The operations of 910 may be performed in accordance with examples as described herein. In some implementations, aspects of the operations of 910 may be performed by a device as described with reference to FIG. 1.

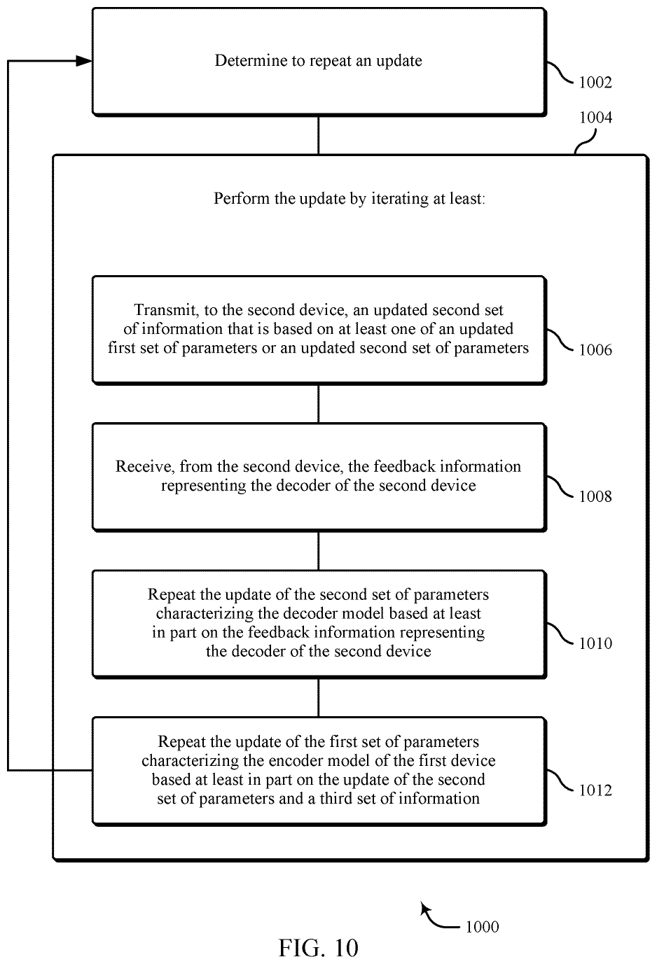

FIG. 10 illustrates a flowchart of a method 1000 that supports two-sided model training in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include determining to repeat an update. The operations of 1002 may be performed in accordance with examples as described herein. In some implementations, aspects of the operations of 1002 may be performed by a device as described with reference to FIG. 1.

At 1004, the method may include performing the update by iterating at least 1006-1012. The operations of 1004 may be performed in accordance with examples as described herein. In some implementations, aspects of the operations of 1004 may be performed by a device as described with reference to FIG. 1.

At 1006, the method may include transmitting, to the second device, an updated second set of information that is based on at least one of an updated first set of parameters or an updated second set of parameters. The operations of 1006 may be performed in accordance with examples as described herein. In some implementations, aspects of the operations of 1006 may be performed by a device as described with reference to FIG. 1.

At 1008, the method may include receiving, from the second device, the feedback information representing the decoder of the second device. The operations of 1008 may be performed in accordance with examples as described herein. In some implementations, aspects of the operations of 1008 may be performed by a device as described with reference to FIG. 1.

At 1010, the method may include repeating the update of the second set of parameters characterizing the decoder model based at least in part on the feedback information representing the decoder of the second device. The operations of 1010 may be performed in accordance with examples as described herein. In some implementations, aspects of the operations of 1010 may be performed by a device as described with reference to FIG. 1.

At 1012, the method may include repeating the update of the first set of parameters characterizing the encoder model of the first device based at least in part on the update of the second set of parameters and a third set of information. The operations of 1012 may be performed in accordance with examples as described herein. In some implementations, aspects of the operations of 1012 may be performed by a device as described with reference to FIG. 1.

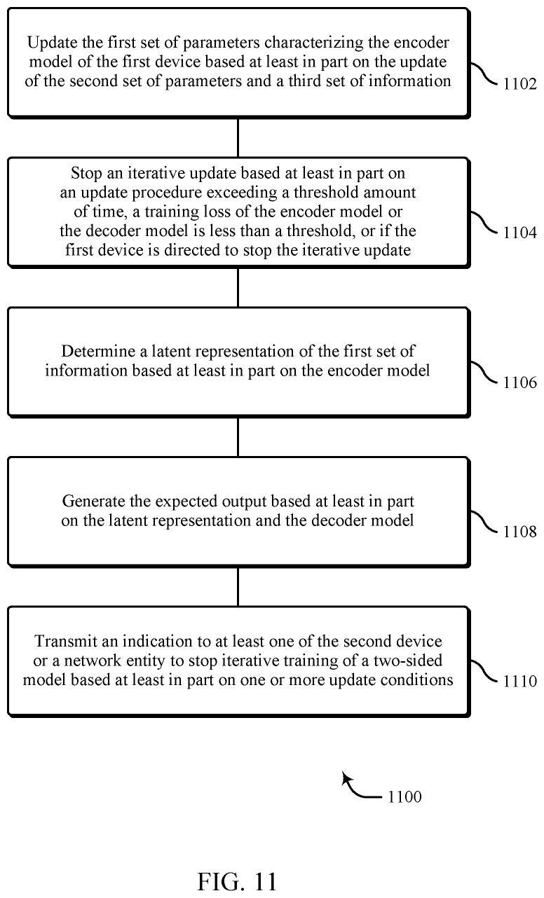

FIG. 11 illustrates a flowchart of a method 1100 that supports two-sided model training in accordance with aspects of the present disclosure. The operations of the method 1100 may be implemented by a device or its components as described herein. For example, the operations of the method 1100 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include updating the first set of parameters characterizing the encoder model of the first device based at least in part on the update of the second set of parameters and a third set of information. The operations of 1102 may be performed in accordance with examples as described herein. In some implementations, aspects of the operations of 1102 may be performed by a device as described with reference to FIG. 1.

At 1104, the method may include stopping an iterative update based at least in part on an update procedure exceeding a threshold amount of time, a training loss of the encoder model or the decoder model is less than a threshold, or if the first device is directed to stop the iterative update. The operations of 1104 may be performed in accordance with examples as described herein. In some implementations, aspects of the operations of 1104 may be performed by a device as described with reference to FIG. 1.

At 1106, the method may include determining a latent representation of the first set of information based at least in part on the encoder model. The operations of 1106 may be performed in accordance with examples as described herein. In some implementations, aspects of the operations of 1106 may be performed by a device as described with reference to FIG. 1.

At 1108, the method may include generating the expected output based at least in part on the latent representation and the decoder model. The operations of 1108 may be performed in accordance with examples as described herein. In some implementations, aspects of the operations of 1108 may be performed by a device as described with reference to FIG. 1.

At 1110, the method may include transmitting an indication to at least one of the second device or a network entity to stop iterative training of a two-sided model based at least in part on one or more update conditions. The operations of 1110 may be performed in accordance with examples as described herein. In some implementations, aspects of the operations of 1110 may be performed by a device as described with reference to FIG. 1.

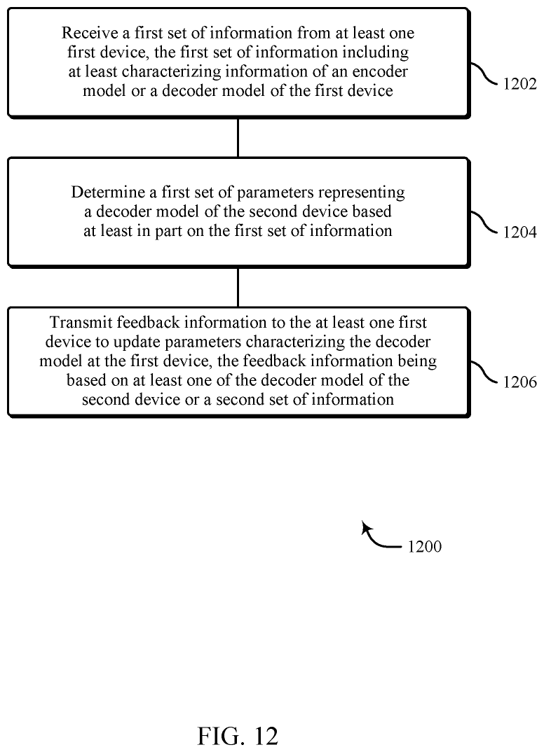

FIG. 12 illustrates a flowchart of a method 1200 that supports two-sided model training in accordance with aspects of the present disclosure. The operations of the method 1200 may be implemented by a device or its components as described herein. For example, the operations of the method 1200 may be performed by a network entity 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include receiving a first set of information from at least one first device, the first set of information including at least characterizing information of an encoder model or a decoder model of the first device. The operations of 1202 may be performed in accordance with examples as described herein. In some implementations, aspects of the operations of 1202 may be performed by a device as described with reference to FIG. 1.

At 1204, the method may include determining a first set of parameters representing a decoder model of the second device based at least in part on the first set of information. The operations of 1204 may be performed in accordance with examples as described herein. In some implementations, aspects of the operations of 1204 may be performed by a device as described with reference to FIG. 1.

At 1206, the method may include transmitting feedback information to the at least one first device to update parameters characterizing the decoder model at the first device, the feedback information being based on at least one of the decoder model of the second device or a second set of information. The operations of 1206 may be performed in accordance with examples as described herein. In some implementations, aspects of the operations of 1206 may be performed by a device as described with reference to FIG. 1.

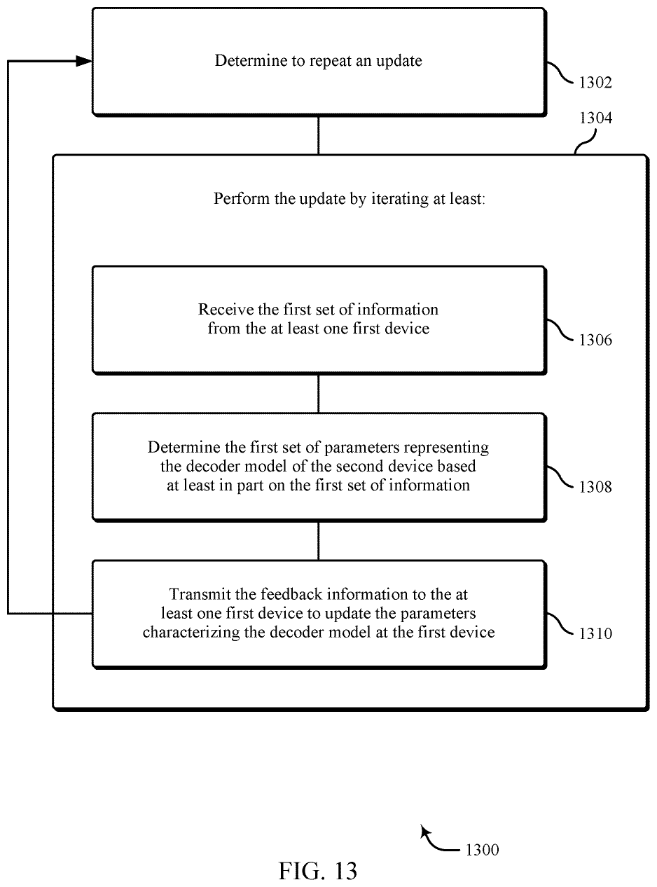

FIG. 13 illustrates a flowchart of a method 1300 that supports two-sided model training in accordance with aspects of the present disclosure. The operations of the method 1300 may be implemented by a device or its components as described herein. For example, the operations of the method 1300 may be performed by a network entity 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include determining to repeat an update. The operations of 1302 may be performed in accordance with examples as described herein. In some implementations, aspects of the operations of 1302 may be performed by a device as described with reference to FIG. 1.

At 1304, the method may include performing the update by iterating at least 1306-1310. The operations of 1304 may be performed in accordance with examples as described herein. In some implementations, aspects of the operations of 1304 may be performed by a device as described with reference to FIG. 1.

At 1306, the method may include receiving the first set of information from the at least one first device. The operations of 1306 may be performed in accordance with examples as described herein. In some implementations, aspects of the operations of 1306 may be performed by a device as described with reference to FIG. 1.

At 1308, the method may include determining the first set of parameters representing the decoder model of the second device based at least in part on the first set of information. The operations of 1308 may be performed in accordance with examples as described herein. In some implementations, aspects of the operations of 1308 may be performed by a device as described with reference to FIG. 1.

At 1310, the method may include transmitting the feedback information to the at least one first device to update the parameters characterizing the decoder model at the first device. The operations of 1310 may be performed in accordance with examples as described herein. In some implementations, aspects of the operations of 1310 may be performed by a device as described with reference to FIG. 1.

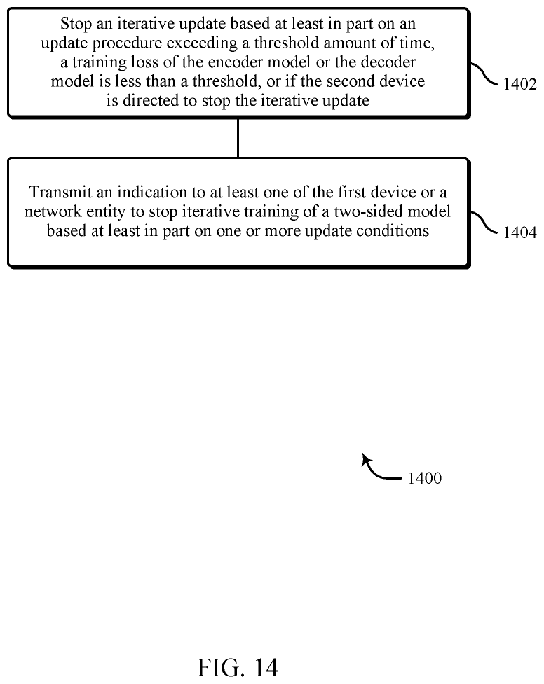

FIG. 14 illustrates a flowchart of a method 1400 that supports two-sided model training in accordance with aspects of the present disclosure. The operations of the method 1400 may be implemented by a device or its components as described herein. For example, the operations of the method 1400 may be performed by a network entity 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1402, the method may include stopping an iterative update based at least in part on an update procedure exceeding a threshold amount of time, a training loss of the encoder model or the decoder model is less than a threshold, or if the second device is directed to stop the iterative update. The operations of 1402 may be performed in accordance with examples as described herein. In some implementations, aspects of the operations of 1402 may be performed by a device as described with reference to FIG. 1.

At 1404, the method may include transmitting an indication to at least one of the first device or a network entity to stop iterative training of a two-sided model based at least in part on one or more update conditions. The operations of 1404 may be performed in accordance with examples as described herein. In some implementations, aspects of the operations of 1404 may be performed by a device as described with reference to FIG. 1.

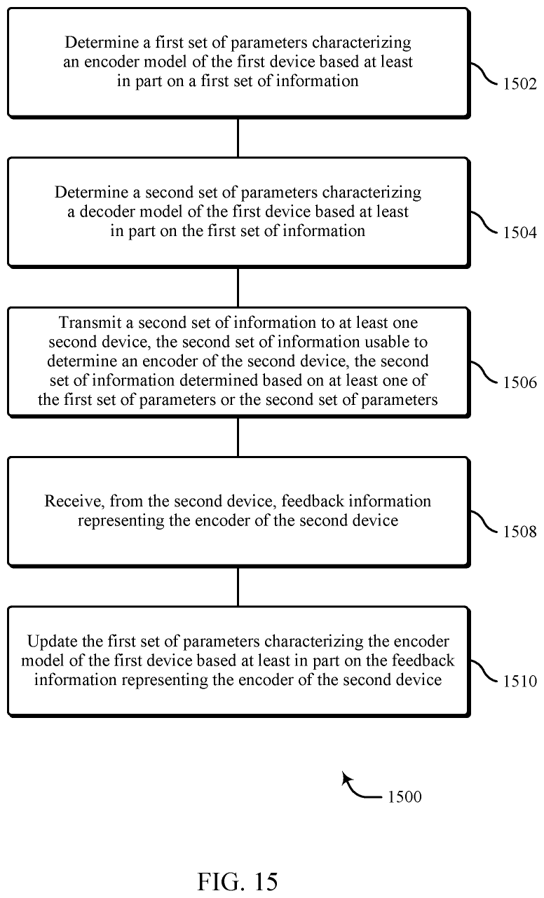

FIG. 15 illustrates a flowchart of a method 1500 that supports two-sided model training in accordance with aspects of the present disclosure. The operations of the method 1500 may be implemented by a device or its components as described herein. For example, the operations of the method 1500 may be performed by a network entity 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1502, the method may include determining a first set of parameters characterizing an encoder model of the first device based at least in part on a first set of information. The operations of 1502 may be performed in accordance with examples as described herein. In some implementations, aspects of the operations of 1502 may be performed by a device as described with reference to FIG. 1.

At 1504, the method may include determining a second set of parameters characterizing a decoder model of the first device based at least in part on the first set of information. The operations of 1504 may be performed in accordance with examples as described herein. In some implementations, aspects of the operations of 1504 may be performed by a device as described with reference to FIG. 1.

At 1506, the method may include transmitting a second set of information to at least one second device, the second set of information usable to determine an encoder of the second device, the second set of information determined based on at least one of the first set of parameters or the second set of parameters. The operations of 1506 may be performed in accordance with examples as described herein. In some implementations, aspects of the operations of 1506 may be performed by a device as described with reference to FIG. 1.

At 1508, the method may include receiving, from the second device, feedback information representing the encoder of the second device. The operations of 1508 may be performed in accordance with examples as described herein. In some implementations, aspects of the operations of 1508 may be performed by a device as described with reference to FIG. 1.

At 1510, the method may include updating the first set of parameters characterizing the encoder model of the first device based at least in part on the feedback information representing the encoder of the second device. The operations of 1510 may be performed in accordance with examples as described herein. In some implementations, aspects of the operations of 1510 may be performed by a device as described with reference to FIG. 1.

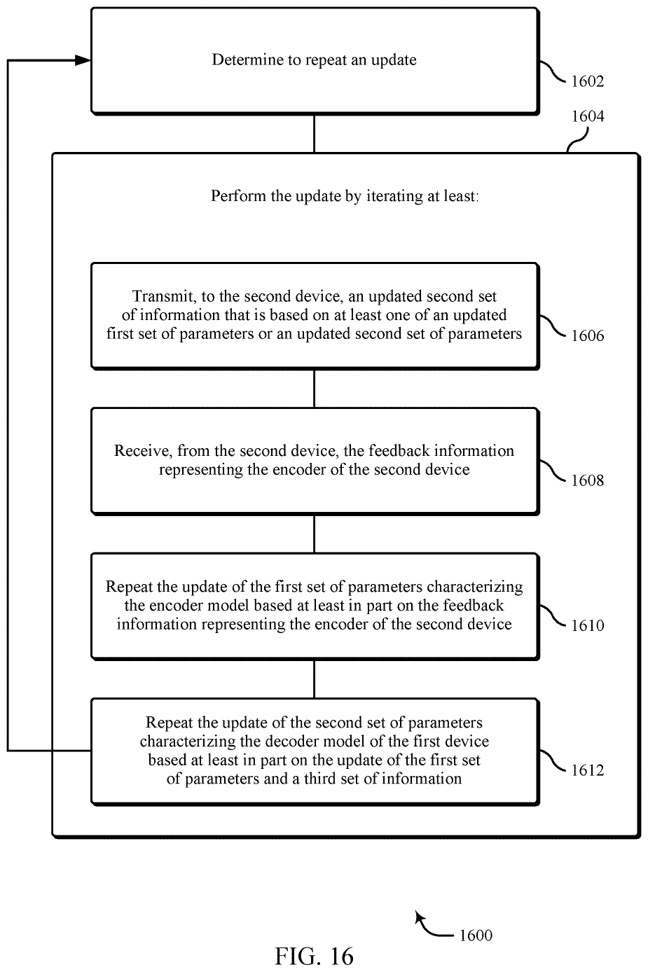

FIG. 16 illustrates a flowchart of a method 1600 that supports two-sided model training in accordance with aspects of the present disclosure. The operations of the method 1600 may be implemented by a device or its components as described herein. For example, the operations of the method 1600 may be performed by a network entity 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1602, the method may include determining to repeat an update. The operations of 1602 may be performed in accordance with examples as described herein. In some implementations, aspects of the operations of 1602 may be performed by a device as described with reference to FIG. 1.

At 1604, the method may include performing the update by iterating at least 1606-1612. The operations of 1604 may be performed in accordance with examples as described herein. In some implementations, aspects of the operations of 1604 may be performed by a device as described with reference to FIG. 1.

At 1606, the method may include transmitting, to the second device, an updated second set of information that is based on at least one of an updated first set of parameters or an updated second set of parameters. The operations of 1606 may be performed in accordance with examples as described herein. In some implementations, aspects of the operations of 1606 may be performed by a device as described with reference to FIG. 1.

At 1608, the method may include receiving, from the second device, the feedback information representing the encoder of the second device. The operations of 1608 may be performed in accordance with examples as described herein. In some implementations, aspects of the operations of 1608 may be performed by a device as described with reference to FIG. 1.

At 1610, the method may include repeating the update of the first set of parameters characterizing the encoder model based at least in part on the feedback information representing the encoder of the second device. The operations of 1610 may be performed in accordance with examples as described herein. In some implementations, aspects of the operations of 1610 may be performed by a device as described with reference to FIG. 1.

At 1612, the method may include repeating the update of the second set of parameters characterizing the decoder model of the first device based at least in part on the update of the first set of parameters and a third set of information. The operations of 1612 may be performed in accordance with examples as described herein. In some implementations, aspects of the operations of 1612 may be performed by a device as described with reference to FIG. 1.

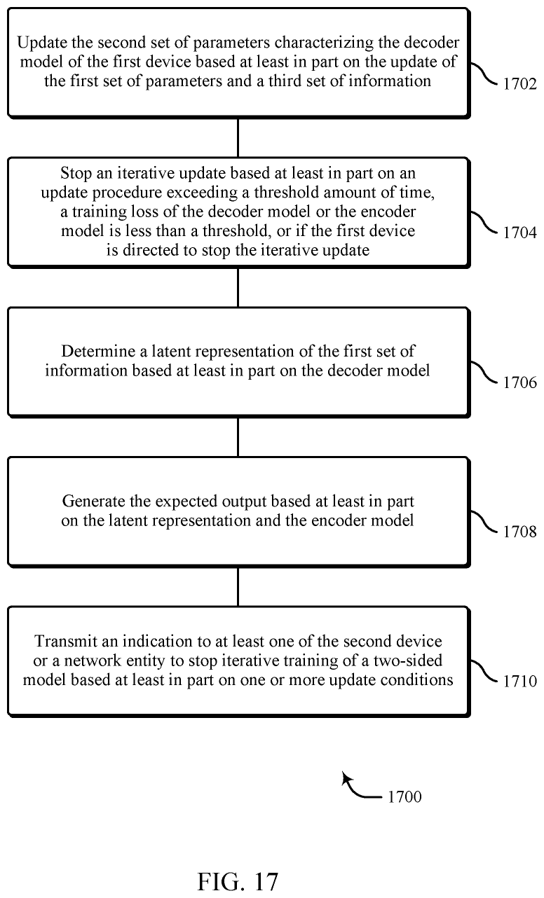

FIG. 17 illustrates a flowchart of a method 1700 that supports two-sided model training in accordance with aspects of the present disclosure. The operations of the method 1700 may be implemented by a device or its components as described herein. For example, the operations of the method 1700 may be performed by a network entity 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1702, the method may include updating the second set of parameters characterizing the decoder model of the first device based at least in part on the update of the first set of parameters and a third set of information. The operations of 1702 may be performed in accordance with examples as described herein. In some implementations, aspects of the operations of 1702 may be performed by a device as described with reference to FIG. 1.

At 1704, the method may include stopping an iterative update based at least in part on an update procedure exceeding a threshold amount of time, a training loss of the decoder model or the encoder model is less than a threshold, or if the first device is directed to stop the iterative update. The operations of 1704 may be performed in accordance with examples as described herein. In some implementations, aspects of the operations of 1704 may be performed by a device as described with reference to FIG. 1.

At 1706, the method may include determining a latent representation of the first set of information based at least in part on the decoder model. The operations of 1706 may be performed in accordance with examples as described herein. In some implementations, aspects of the operations of 1706 may be performed by a device as described with reference to FIG. 1.

At 1708, the method may include generating the expected output based at least in part on the latent representation and the encoder model. The operations of 1708 may be performed in accordance with examples as described herein. In some implementations, aspects of the operations of 1708 may be performed by a device as described with reference to FIG. 1.

At 1710, the method may include transmitting an indication to at least one of the second device or a network entity to stop iterative training of a two-sided model based at least in part on one or more update conditions. The operations of 1710 may be performed in accordance with examples as described herein. In some implementations, aspects of the operations of 1710 may be performed by a device as described with reference to FIG. 1.

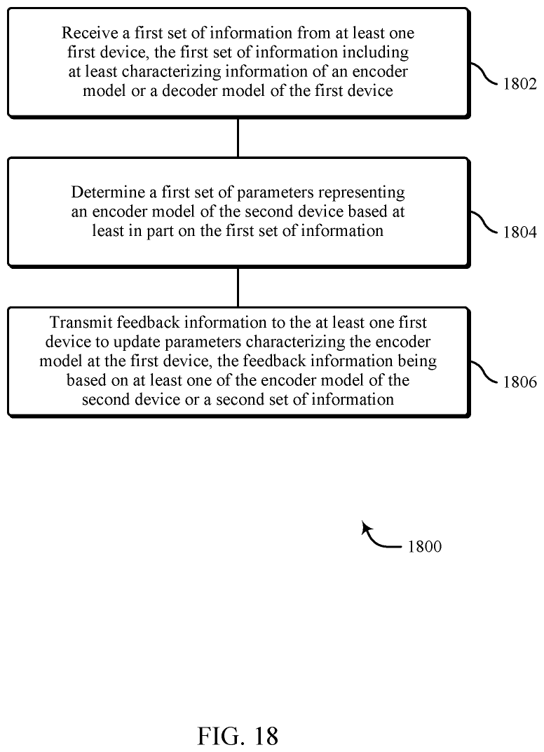

FIG. 18 illustrates a flowchart of a method 1800 that supports two-sided model training in accordance with aspects of the present disclosure. The operations of the method 1800 may be implemented by a device or its components as described herein. For example, the operations of the method 1800 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1802, the method may include receiving a first set of information from at least one first device, the first set of information including at least characterizing information of an encoder model or a decoder model of the first device. The operations of 1802 may be performed in accordance with examples as described herein. In some implementations, aspects of the operations of 1802 may be performed by a device as described with reference to FIG. 1.

At 1804, the method may include determining a first set of parameters representing an encoder model of the second device based at least in part on the first set of information. The operations of 1804 may be performed in accordance with examples as described herein. In some implementations, aspects of the operations of 1804 may be performed by a device as described with reference to FIG. 1.

At 1806, the method may include transmitting feedback information to the at least one first device to update parameters characterizing the encoder model at the first device, the feedback information being based on at least one of the encoder model of the second device or a second set of information. The operations of 1806 may be performed in accordance with examples as described herein. In some implementations, aspects of the operations of 1806 may be performed by a device as described with reference to FIG. 1.

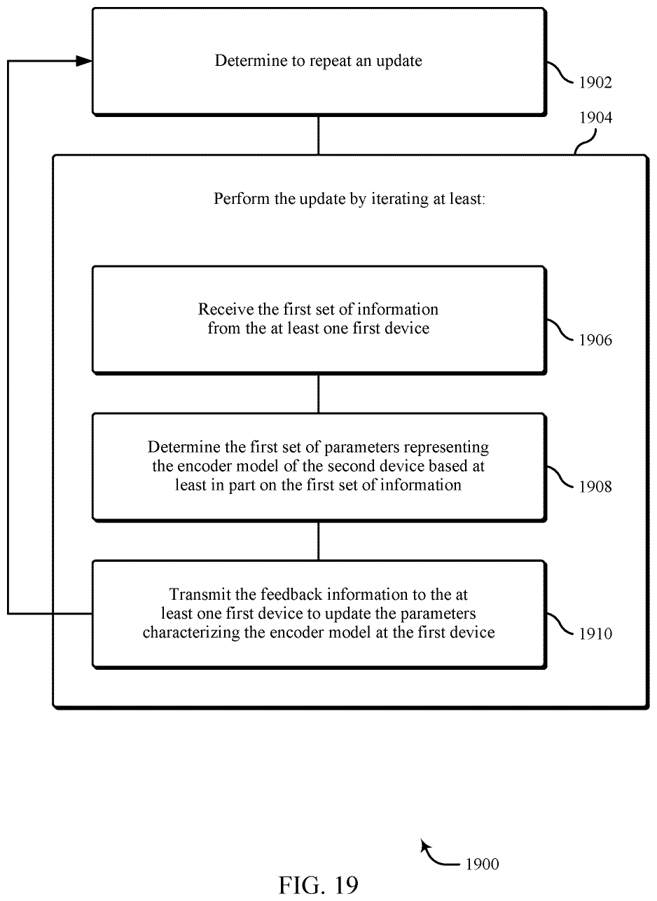

FIG. 19 illustrates a flowchart of a method 1900 that supports two-sided model training in accordance with aspects of the present disclosure. The operations of the method 1900 may be implemented by a device or its components as described herein. For example, the operations of the method 1900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1902, the method may include determining to repeat an update. The operations of 1902 may be performed in accordance with examples as described herein. In some implementations, aspects of the operations of 1902 may be performed by a device as described with reference to FIG. 1.

At 1904, the method may include performing the update by iterating at least. The operations of 1904 may be performed in accordance with examples as described herein. In some implementations, aspects of the operations of 1904 may be performed by a device as described with reference to FIG. 1.

At 1906, the method may include receiving the first set of information from the at least one first device. The operations of 1906 may be performed in accordance with examples as described herein. In some implementations, aspects of the operations of 1906 may be performed by a device as described with reference to FIG. 1.

At 1908, the method may include determining the first set of parameters representing the encoder model of the second device based at least in part on the first set of information. The operations of 1908 may be performed in accordance with examples as described herein. In some implementations, aspects of the operations of 1908 may be performed by a device as described with reference to FIG. 1.

At 1910, the method may include transmitting the feedback information to the at least one first device to update the parameters characterizing the encoder model at the first device. The operations of 1910 may be performed in accordance with examples as described herein. In some implementations, aspects of the operations of 1910 may be performed by a device as described with reference to FIG. 1.

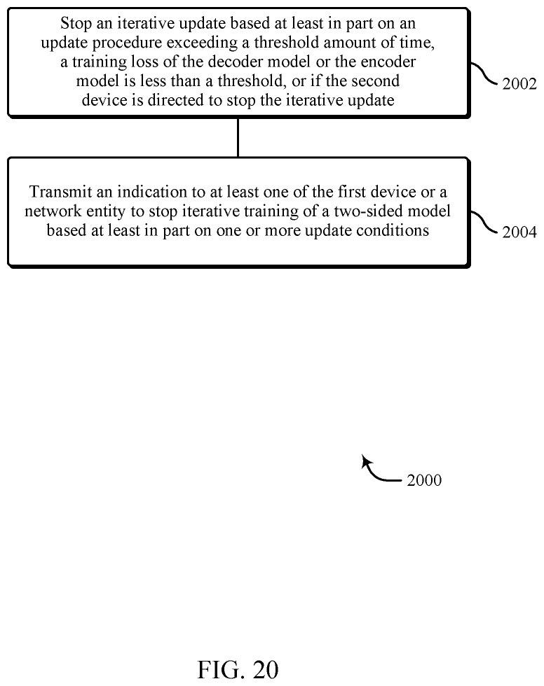

FIG. 20 illustrates a flowchart of a method 2000 that supports two-sided model training in accordance with aspects of the present disclosure. The operations of the method 2000 may be implemented by a device or its components as described herein. For example, the operations of the method 2000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 2002, the method may include stopping an iterative update based at least in part on an update procedure exceeding a threshold amount of time, a training loss of the decoder model or the encoder model is less than a threshold, or if the second device is directed to stop the iterative update. The operations of 2002 may be performed in accordance with examples as described herein. In some implementations, aspects of the operations of 2002 may be performed by a device as described with reference to FIG. 1.

At 2004, the method may include transmitting an indication to at least one of the first device or a network entity to stop iterative training of a two-sided model based at least in part on one or more update conditions. The operations of 2004 may be performed in accordance with examples as described herein. In some implementations, aspects of the operations of 2004 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A wireless node for wireless communication, comprising:
at least one memory; and
at least one processor coupled with the at least one memory and operable to cause the wireless node to:
determine a first set of parameters characterizing an encoder model of the wireless node based at least in part on a first set of information;
determine a second set of parameters characterizing a decoder model of the wireless node based at least in part on the first set of information;
receive, from a network entity (NE), feedback information representing a decoder of the NE;
update the second set of parameters characterizing the decoder model of the wireless node based at least in part on the feedback information representing the decoder of the NE; and
update the first set of parameters characterizing the encoder model of the wireless node based at least in part on the update of the second set of parameters and a second set of information that includes a set of samples representing at least input data and an expected output of a complete encoder-decoder model.

2. The wireless node of claim 1, wherein the at least one processor is operable to cause the wireless node to use an updated encoder model of the wireless node to generate feedback data for transmission to another wireless node.

3. The wireless node of claim 1, wherein:
the at least one processor is operable to cause the wireless node to update the first set of parameters characterizing the encoder model of the wireless node based at least in part on training the encoder model which is concatenated serially with the updated decoder model generates to generate approximately similar input and output data pairs at least for the set of samples of the second set of information.

4. The wireless node of claim 1, wherein the at least one processor is operable to cause the wireless node to:
determine to repeat an update; and
perform the update by iterating at least to:
receive, from the NE, the feedback information representing the decoder of the NE;
repeat the update of the second set of parameters characterizing the decoder model based at least in part on the feedback information representing the decoder of the wireless node; and
repeat the update of the first set of parameters characterizing the encoder model of the wireless node based at least in part on the update of the second set of parameters and a third set of information.

5. The wireless node of claim 1, wherein the first set of information includes data samples representing at least an input and an expected output of a two-sided model that includes the encoder model and the decoder model of the wireless node, and wherein the first set of information and output data of the two-sided model are based at least in part on channel state information (CSI).

6. The wireless node of claim 5, wherein the at least one processor is operable to cause the wireless node to:
determine a latent representation of the first set of information based at least in part on the encoder model; and
generate the expected output based at least in part on the latent representation and the decoder model.

7. The wireless node of claim 1, wherein the first set of parameters and the second set of parameters are utilized to determine neural network (NN) parameters of one or more NN modules associated with the encoder model and the decoder model.

8. The wireless node of claim 1, wherein the expected output of the complete encoder-decoder model matches the input data.

9. The wireless node of claim 1, wherein the decoder model generates approximately similar input and output data pairs at least for samples of the feedback information based at least in part on the second set of parameters being updated to characterize the decoder model.

10. The wireless node of claim 1, wherein the first set of information is at least one of collected at the wireless node, measured by the wireless node, or received from the NE.

11. The wireless node of claim 1, wherein the first set of information includes at least one of a structure or weights of at least one neural network model.

12. (canceled)

13. A network entity (NE) for wireless communication, comprising:
at least one memory; and
at least one processor coupled with the at least one memory and operable to cause the NE to:
determine a first set of parameters representing a decoder model of the NE based at least in part on a first set of information; and
transmit feedback information to at least one wireless node to update parameters characterizing the decoder model at the wireless node, the feedback information being based on at least one of the decoder model of the NE or a second set of information.

14. The NE of claim 13, wherein the at least one processor is operable to cause the NE to:
determine to repeat an update; and
perform the update by iterating at least to:
receive the first set of information from the at least one wireless node;
determine the first set of parameters representing the decoder model of the NE based at least in part on the first set of information; and
transmit the feedback information to the at least one wireless node to update the parameters characterizing the decoder model at the wireless node.

15. The NE of claim 13, wherein the first set of information includes the characterizing information of the decoder model of a two-sided model, and wherein the first set of information includes data samples representing at least an input and an expected output of the decoder model of the two-sided model.

16. The NE of claim 13, wherein the first set of parameters are utilized to determine neural network (NN) parameters of one or more NN modules associated with the decoder model.

17. The NE of claim 13, wherein the first set of parameters are determined such that the decoder model generates approximately similar input and output data pairs at least for samples of the first set of information.

18. The NE of claim 13, wherein the at least one processor is operable to cause the NE to stop an iterative update based at least in part on an update procedure exceeding a threshold amount of time, a training loss of an encoder model or a decoder model is less than a threshold, or if the NE is directed to stop the iterative update.

19. The NE of claim 13, wherein the at least one processor is operable to cause the NE to communicate an indication to the at least one wireless node to stop iterative training of a two-sided model based at least in part on one or more update conditions.

20. A network entity (NE) for wireless communication, comprising:
at least one memory; and
at least one processor coupled with the at least one memory and operable to cause the NE to:
determine a first set of parameters characterizing an encoder model of the NE based at least in part on a first set of information;
determine a second set of parameters characterizing a decoder model of the NE based at least in part on the first set of information;
receive, from a wireless node, feedback information representing the encoder of the wireless node; and
update the first set of parameters characterizing the encoder model of the NE based at least in part on the feedback information representing the encoder of the wireless node.

21. A method performed by a wireless node, the method comprising:
determining a first set of parameters characterizing an encoder model of the wireless node based at least in part on a first set of information;
determining a second set of parameters characterizing a decoder model of the wireless node based at least in part on the first set of information;
receiving, from a network entity (NE), feedback information representing a decoder of the NE;
updating the second set of parameters characterizing the decoder model of the wireless node based at least in part on the feedback information representing the decoder of the NE; and
updating the first set of parameters characterizing the encoder model of the wireless node based at least in part on the update of the second set of parameters and a second set of information that includes a set of samples representing at least input data and an expected output of a complete encoder-decoder model.
